(19) United States
(12) Patent Application Publication
(10) Pub. No.: US 2004/0155088 A1
(43) Pub. Date: Aug. 12, 2004

(54) Felting apparatus and method

(75) Inventors: George Smeja, McHenry, IL (US); Michael V. Smeja, McHenry, IL (US); Troy Livingston, Northbrook, IL (US)

Correspondence Address: FITCH EVEN TABIN AND FLANNERY, 120 SOUTH LA SALLE STREET, SUITE 1600, CHICAGO, IL, 60603-3406, US

(73) Assignee: Master Products, Inc.

(21) Appl. No.: 10/653,393

(22) Filed: Sep. 2, 2003

Related U.S. Application Data
(60) Provisional application No. 60/408,535, filed on Sep. 5, 2002.

(51) Int. Cl. B25C 5/06

(52) U.S. Cl. 227/140; 227/110

(57) ABSTRACT

A method and apparatus for fastening an elongated strip such as a felting strip or the like to a roof with the rolling of the apparatus along the roof. Preferably, the machine applies the staples at an acuate angle of about 30° to 40° to the longitudinal axis of the strip and staple gun extends at the acute angle with the user's arm also extending at this acute angle. The staple gun must be enabled by placing it against the roof before an actuation of the trigger will cause a firing of the staple. The strip may be mounted in a reel that is in a substantially vertical plane with a strip guide and point of application of the strip to the roofing felt so that the strip is not twisted in its travel from the reel to the roof. The strip may be severed by a severing device, as when reaching an edge of the roof, and automatic strip advancing device may be actuated to advance a new leading end of the strip for placement beneath the nose of the staple gun. An automatic firing mechanism may be enabled for automatically applying staples to the strip at equal intervals along the length of the strip; or the automatic firing mechanism may be disabled and a manual trigger may be actuated to fire the staple gun. An elongated strip having a thickness of about 0.010 inch thickness is made with laminated layers with a first layer molecularly oriented to provide high tensile strength and a second layer of softer polyfilm to reduce tearing when the strip is stretched and begins to tear at a staple.

This application claims the benefit of U.S. Provisional Patent Application No. 60/408,535, Filed Sep. 5, 2002.

### FIELD OF THE INVENTION

This invention relates to a method of and an apparatus for securing the elongated member such as a strip over a construction material such as a roofing felt sheet to an underlying support such as a roof.

### BACKGROUND OF THE INVENTION

A known problem which has resisted satisfactory solution, until now, is the securing of roofing felt sheets to the building until the shingles or metal roof covers and is secured over the main roof. Often because of scheduling problems in obtaining or laying the shingles or the metal roof, the roofing felt is left exposed for days or several weeks. There are certain UL tests that desire to have an uplift and test for a wind of 60 mph. Compounding the problem is that after the roof felt sheet is applied, the builder may leave the doors and windows open and in a high wind storm the pressures of the wind provides an uplifting force tending to bow the felting sheet upwardly. Once an edge of the roofing felt is lifted and begins to tear an expensive and difficult repair problem occurs.

The roofing sheet is very flexible material and is easily torn or otherwise loses its integrity, even in the face of minor wind. It is desirable to avoid this wind damage to the roofing felt sheet. For once the roofing felt sheet is torn or otherwise breeched, it is difficult to effectively repair the same.

It is also costly to replace the roofing felt sheet, both in terms of workers' time, material costs, and contract deadlines for finishing the roof. Along with the difficulty of patching the torn roofing felt sheet, the patch itself is a major defect in the felt. Thus, a roofer always has a big problem with the wind.

The roofing felt sheet is critical, as an undergirding support, for a proper roof, whether the top or exposed cover for the roof makes the roof a metal roof, a shingle roof, a slate roof, or any other type of roof. If the roofing felt sheet maintains its integrity, is not torn or otherwise damaged, and covers the roof effectively, a good roof may be obtained.

The wind can tear the roofing felt sheet from its support in spite of the felt fastening devices of the prior art. A number of fastening devices for roof felt exist, all in a futile attempt to overcome this problem.

One of the standard roofing attempts is a nail and a button. The button provides a greater surface area for holding down the roofing felt sheet. However, the roofing felt sheet is still subject to the wind. Furthermore, the button has a necessary thickness in order to provide the support. This thickness however interferes with the over layment for the roof, being placed over the roofing felt sheet. In this fashion, such over underlayment becomes difficult to handle.

Over underlayment of the buttons is especially a problem with a metal roof. A piece of metal landing on the button will eventually lose its integrity and permit rain or other undesirable material to pass through the metal and ruin the structure under the roof. It is therefore desirable to apply an efficient hold down method for roofing felt sheets.

The buttons, the nails, and the staples; which are all known to hold down the roofing felt sheet; do not achieve this good hold down capability in the face of a wind. Thus, it is desired to provide this hold down capability. Additionally, such a device must not greatly increase the bulk or the weight of the device being used to secure the roofing felt sheet to the roof.

In some instances thin strips of wood are nailed or otherwise secured over the felt, in order to minimize tearing. This wood, also known as lath, with its nails, creates a greater problem than the buttons. The lath, with its nails therein, must be removed before the felt can be covered, with a top portion of roofing material. Disposal of the lath and nail combination creates a safety hazard on the job site. It is very desirable to avoid this problem.

In the prior attempts to provide a tool to secure roofing felt or the like to a building is that disclosed in U.S. Pat. No. 3,771,708, which has the concept of using a stapler to staple a strip along the edges of the roofing felt sheets. There are a number of practical considerations that may have precluded the commercial use in large scale of the prior art devices. An obvious consideration is cost. The tool cannot be expensive. In addition to being inexpensive, the tool must be rugged and strong so that it can be dropped or thrown into a truck without being damaged. Morever, the tool should be capable of laying the strip and stapling the strip and the roofing felt to the underlying main roof when the roof felt is very hot and there could be an accumulation of tar on the stapling machine. Preferably, the staple should be applied so that it can't show when someone walks on the shingles or metal roof overlaying the staple. Also, there is the problem of ergonomics in that the machine user should be able to use the machine for large roofs and for long periods of time without undue stress on the user's body. Safety is also a concern so that the staple gun is not accidentally firing a staple into a person. The tool should be small and lightweight as it must be carried up ladders to a roof and rolled along the roof. These and other practical problems should be addressed and solved to result in a commercially acceptable machine. There is a need to develop such an acceptable machine that heretofore has been attempted unsuccessfully.

### BRIEF SUMMARY OF THE INVENTION

In accordance with the preferred embodiment, there is provided a new and improved method and machine for fastening an elongated strip to secure a construction material such as a felting sheet to a building. This is achieved by a machine that is rolled along the roofing felt laying the strip as it travels with the staple head or nose of the stapling machine holding the strip against the roof felt and the stapling machine being enabled to apply staples to the strip and to the roofing felt

In accordance with another embodiment, an automatic firing mechanism is provided to fire fasteners at predetermined intervals of carriage travel along the roofing felt. Thus, the strips will be stapled at set spacings without the operator having to pull a trigger to fire each staple. In other embodiments, the staples are applied when a person pulls a trigger to drive a staple.

From an ergonomic standpoint, the preferred machine is balanced such that the user may lean on the machine and roll it in a straight line much like moving the wheels of a skateboard forwardly in a straight line while the user's arm is extended as if the user were walking horizontally along the roof with his hand extended outwardly and upwardly to touch the roof. Usually, this angle is an acute angle in the range of about 30° to 40°, with 35° being preferred. In the preferred embodiment of the machine, the stapler gun is disposed outwardly and at an angle in this range and the machine is balanced so that the handle grip with the user's hand is straight over the top of the handle, as the machine is rolled horizontally across the roof.

In accordance with this embodiment, the staple gun is located at an acute angle to the travel path of the machine and to the longitudinal axis of the strip; and likewise the staples are stapled at this acute angle to hold the strip and roofing felt to the roof.

In another embodiment, the stapler will not fire a staple even though the user has pulled the trigger to fire the staple unless the safety device has been also simultaneously actuated with engagement with the roof so as to enable or condition the machine to allow a staple to be driven. Thus, when the machine is lifted from the roof and the trigger is pulled the staple will not be fired because the safety device has not been operated. In this other embodiment, as soon as the machine is pressed against the roof, the safety device is actuated thereby enabling a subsequent application of a staple. In the other illustrated embodiment, the safety device is not actuated when the machine is pressed against roofing felt and rolled therealong. In this embodiment, the safety device has a safety plunger which is spaced from the strip and roofing felt by a short distance until a forward end of the machine is rocked into engagement with the strip to operate the safety plunger and then the trigger may be pulled to apply a staple or an automatic firing mechanism may be used to apply staples at equal intervals along the strip.

From a strip guidance and application standpoint, the strip is preferably mounted in a reel in a substantially vertical plane with a strip guidance or advancement device, and the point of application of the strip to the roofing felt, and in the same vertical plane. That is, preferably, the strip is fed from the reel and travels in a common vertical plane so that it is not bent, twisted or made to travel sideways while traveling about a curve. Herein, the strip is preferably unwound from the top of the reel, which is in the vertical plane and is rotating about a horizontal axis, and fed across the top of the machine to the front of the machine where the strip travels downwardly to the point of application to the roofing felt with the strip being applied beneath the machine as the machine is rolled forwardly. In this manner, the strip travels in a common vertical plane from a reel that is vertically aligned over the top of the previously laid strip such that the strip is never twisted in its travel and is much more easily guided.

Preferably, a reel support and tension device holds the reel against freely shifting and applies tension to the strip as it is pulled from the roll. Herein, the reel support and tension device is a spring clip into which the reel is inserted with the spring clip being spread by the inserted reel.

The preferred machine is also provided with an automatic strip advance device to advance a length of the strip from the reel. In the preferred embodiment, a strip severing device is actuated, as when reaching an edge of the roof and an edge of the roofing felt, to sever the previously laid strip from the rest of the strip wound in a coil on the reel on the machine. To feed this remaining strip forwardly towards the point of application to the roofing felt, an automatic feed device is operated which advances the strip which is then laid on the roofing felt and stapled to commence the next strip application across the next sheet of roofing felt. Herein, the strip feeder comprises a fluid cylinder operable to shift a strip engaging pawl forwardly to unwind a predetermined length, e.g., two to three inches of strip from the reel and to feed downwardly this strip from the severing station toward the stapler nose. Usually, the user will do two or more strip advancements to advance about five or six inches or so of strip before stapling this end of the strip to this next roofing felt. Thus, there is provided a simple and inexpensive device for advancing the cute end of the strip forwardly at the start of a strip applying operation.

Herein, the preferred strip for being stapled by the machine is one that is inexpensive, has good tensile strength, maintains its strength on a hot roof, e.g., up to 185° F., good UV resistance and reasonable tear resistance to tearing if slight notched or cut along an edge of the strip. A polyester, extruded strip or band or a Dacron band is suitable. Also, it is preferred that the machine have a relatively large reel of the strip, e.g., 900 to 1000 feet in length and not to be to heavy, e.g., above ten pounds in weight. Likewise, because the machine itself must be carried up ladders and carried to the point of use, it is most desirable that the machine be lightweight, e.g., under five pounds or less without the reel; and, yet be rugged to withstand rough treatment from roofers.

### BRIEF DESCRIPTION OF THE DRAWINGS

Throughout the figures of the drawings, where the same part appears in more than one figure of the drawings, the same number is applied thereto.

FIG. 1 is a perspective view of a strip applying and fastening apparatus constructed in accordance with the preferred embodiment of the invention;

FIG. 1A is a view of a roof showing wind blowing under and lifting a roofing felt from the roof;

FIG. 1B illustrates a strip attached by staples to hold the roofing felt to the roof in accordance with the preferred embodiment of the invention;

FIG. 2 is an illustration of the machine with the side cover removed from the apparatus shown in FIG. 1;

FIG. 3 is an opposite side view from that shown in FIG. 2 of the apparatus for applying the strip as shown in FIG. 1;

FIG. 4 illustrates a cross-sectional view of the staple fastening the strip and the roofing felt edge to the underlying roof;

FIG. 5 is a plan view of the apparatus shown in FIGS. 2 and 3;

FIG. 6 is a side elevational view of the apparatus shown in FIGS. 2 and 3;

FIG. 7A is a view showing the apparatus in its stapling position after being rocked from the strip applying position of FIG. 7B;

FIG. 7B illustrates the strip applying position prior to applying a staple to the strip as shown in FIG. 7A;

FIG. 8 is a side elevational view of another embodiment of the invention for stapling a strip to a roof;

FIG. 9 is an enlarged front section showing air safety switch and a wheel being pivotally mounted to be raised and lowered relative to the remainder of the apparatus;

FIG. 10 is another perspective view of the machine of FIGS. 8 and 9;

FIG. 11 is a front perspective view of the machine;

FIG. 12 is a perspective view showing a spring clip for retaining a coiled reel of strip within a cover;

FIG. 13 is a perspective view showing a strip guide delivering a strip beneath a nose of the staple in accordance with a third embodiment;

FIG. 14 is a side elevational view of the device of FIG. 13;

FIG. 15 is a front perspective view of the device of FIG. 13;

FIG. 16 is a partial side elevational view of another embodiment having an automatic firing mechanism for automatically applying fasteners to the strip at constant spaced intervals along the strip and roofing felt;

FIG. 17 is a front elevational view of the FIG. 16 embodiment;

FIG. 18A is a view of a measuring roller with pin inserts positioned on a measuring roller to cause fastener operation every 180° of rotation of the measuring roller;

FIG. 18B is a view with one pin insert in the operative position to cause application of a fastener once every revolution of the measuring roller;

FIG. 18C is a view with both pin inserts in their inoperative positions thereby disabling the automatic firing mechanism;

FIG. 19 is a cross-sectional view of a pin insert;

FIG. 20 is a longitudinal elevational view of the pin insert;

FIG. 21 is a longitudinal, elevational view of the pin insert; and

FIG. 22 is a cross-section of a laminated strip.

### DESCRIPTION OF THE PREFERRED EMBODIMENTS

An apparatus for applying an elongated member to roofing felt and holding an elongated member to the roofing felt with a fastener feeds the elongated member through a fastening device and provides for the elongated member to be held in a desired position. Preferably, the fastening device places the elongated member under the fastener or series of fasteners dispensed therefrom, and applied thereover at spaced intervals, in order to secure the roofing felt to the roof.

With this apparatus for securing a roofing sheet to a roof fastener, in a preferred form, a staple gun may be used to fasten the roofing felt sheet to the roof. With the particular staple gun of this invention, an elongated member is fed under the staple delivery point of the staple gun. Thus, as the roofer advances on the roof and applies a staple into felt, an elongated member is fed under the staple. The staple and series thereof are applied over the elongated member. The elongated member is thus held on the roofing felt. With the extra holding power of the elongated member combined with the series of staples, extra holding power is provided for the roofing felt, thereby greatly reducing torn roofing felt.

Typical required properties of the elongated members suitable for use in this invention are flexibility for installation, durability for holding power, capability of being stored on or fed from a reel, and capability of passing under a staple. Some examples of elongated members include; but are not limited to; a strap, a flexible wire, a fishing line, an elongated filament being single or multi stranded, and a band.

Of course, other fasteners besides staples and other fastening devices besides staple guns are usable herein. However, staples and staple guns are the preferred fastener and fastening device.

As the staples are placed within a reasonable range apart on the roof, an elongated member is fed thereunder. The staples combined with a line or a strap greatly reduce or eliminate wind damage to roofing felt sheet underlayment for a roof. A line, a strap or other elongated member, combined with the staple, prohibits the wind from getting under the roofing felt sheet and forcing the roofing felt sheet to tear due to wind shear. In this fashion, it is more efficient to stop the tearing of the roofing felt sheet. With such a holding mechanism for the roofing felt sheet in place, the finishing of the roof is more efficient, and the roof lasts substantially longer.

As a further reinforcement of the felt sheet in its adherence to a roof, one or more strap supports may run the length of the felt roll. Such a strap support strengthens the felt sheet against tearing. The strap support may even have an adhesive thereon, in order to assist in the holding down of the felt. Such a strap support effectively receives a series of staples, for holding the felt sheet in position.

The staples may be used with or without the elongated member, if the strap support is present. The elongated member in combination with the strap support provides the greatest support to the felt sheet.

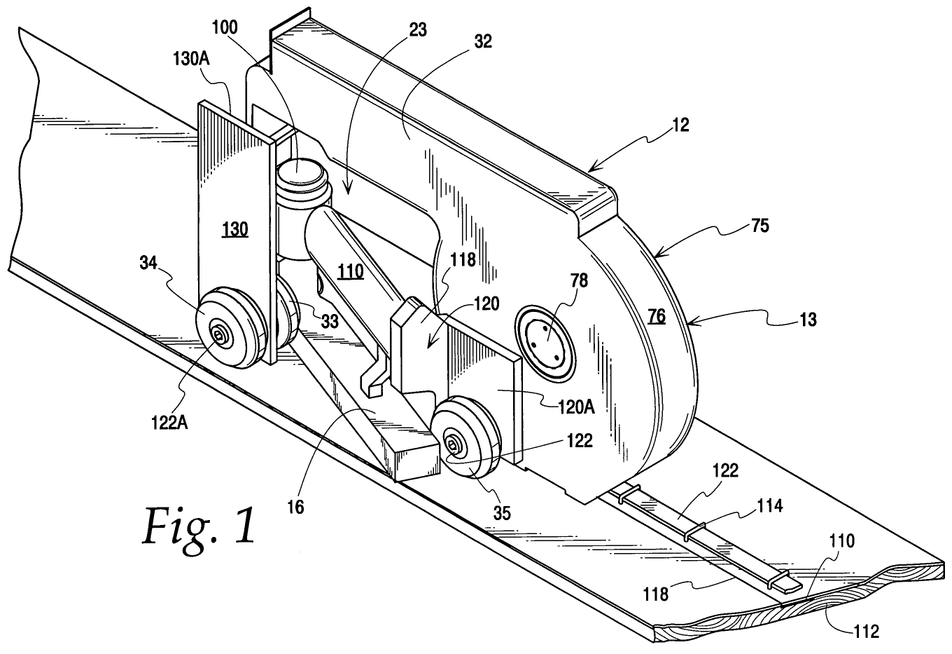

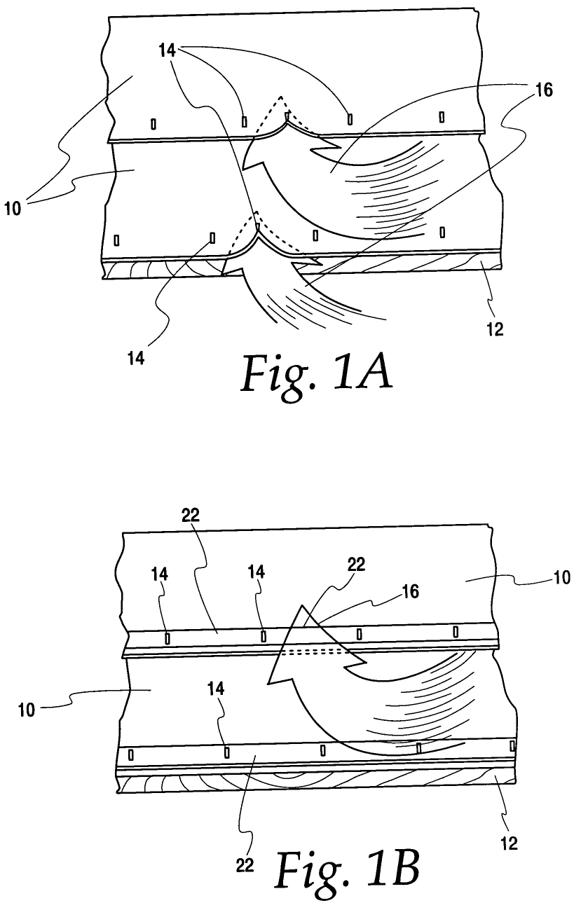

In FIG. 1A, two pieces of roofing felt sheet 10 are attached to a roof 12 and secured thereto by staples 14. Arrows 16 indicate how a wind force may get under the roofing felt sheet 10 and cause tearing thereof. More specifically, arrows 16 show the attack of the wind force on the roofing felt sheet 10, between the staples 14 as causing undesirable tearing of the roofing felt sheet 10 at edge 18, thereof.

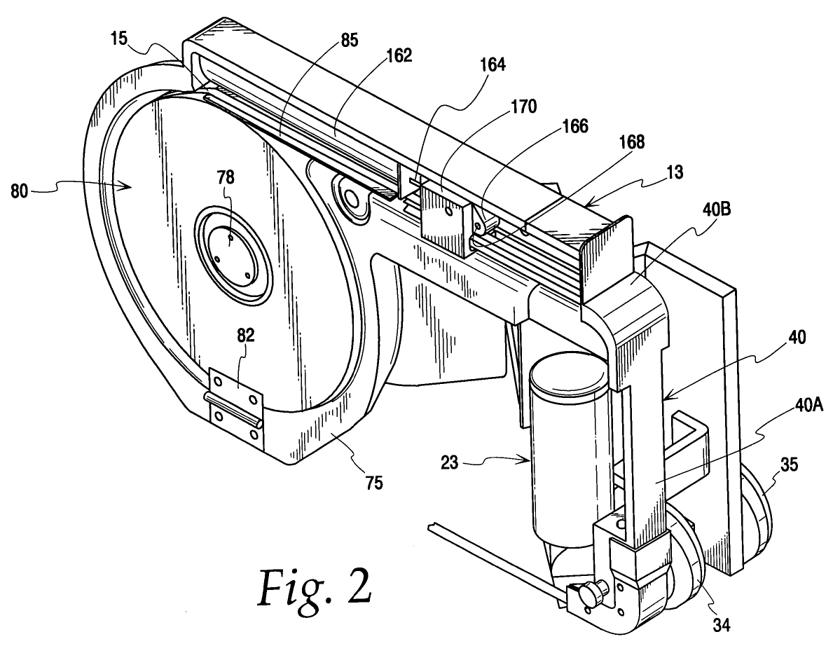

In FIG. 2A, there is depicted securing assembly for use on roof 12 with the roofing felt sheet 10 and the staples 14 holding the roofing felt sheet 10. However, wind, as indicated by arrows 16, cannot penetrate sufficiently to cause tearing of the roofing felt sheet 10 because of strip 22 secured thereover by the staples 14. The staples 14 combined with the strip 22 prohibit the lifting of the roofing felt sheet 10 for tearing purposes. In this fashion, the desired protection of preventing or reducing the tendency of the roofing felt sheet 10 to tear due to wind shear is provided. More particularly, strip 22 provides continuous support of roofing felt sheet 10 along the entire longitudinally extending edge 18 of the roofing felt sheet.

As shown in the drawings for purposes of illustration, there is shown a strip applying and securing device 11 (FIGS. 1 and 2) that comprises a wheeled tool or carriage 13 having wheels for rolling along the roofing felt sheet 10 and for securing an elongated member, illustrated herein as a strip 12 to the roof 12. The wheeled carriage carries a wound reel 15 of the strip material that is fed from the reel 15 to a point of application 19 at which the strip is applied to the roof. The strip is secured to the roofing felt 10 by the fasteners in the form of staples 14 fed from a supply or magazine 20 staples to a fastening device or powered applicator such as a powered staple gun 23 that is, in this instance, powered by a fluid source such as compressed air to drive the staples into the strip and to drive the staple legs into the underlying main roof 12. Manifestly, the gun 23 may be driven by an electric motor or other powered device rather than the illustrated pneumatic cylinder.

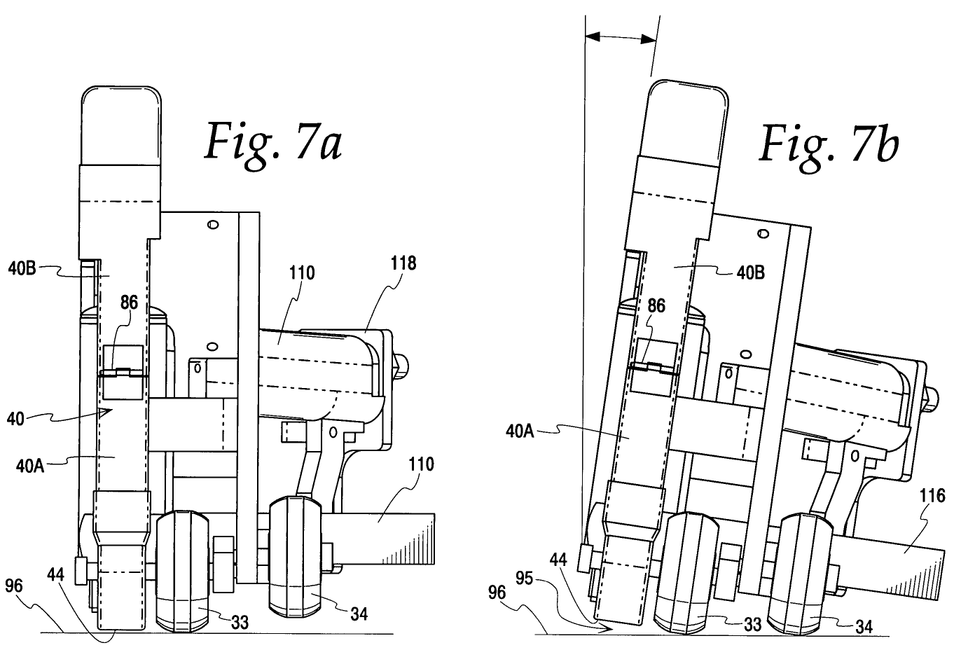

In accordance with the first illustrated embodiment, the strip 22 is laid along the felt roof sheet 10 parallel to an edge of the felt sheet as the carriage 13 is rolled therealong, as best seen in FIG. 7B until it is desired to fasten the strip, at which time the operator actuates the power driven applicator as by pulling a trigger, and thereby a firing of the staple, into the strip to fasten it and the roofing felt material to underlying main roof 12. The carriage is then rolled along the roof to lay down more strip on the roofing felt until it is desired to again secure the strip 22 to the main roof 12. As will be explained in an embodiment of the invention described subsequent to the description of this embodiment, a pressing of the applicator nose tightly against the strip and tightly against the roofing felt; and then a pulling of the trigger applies the staple.

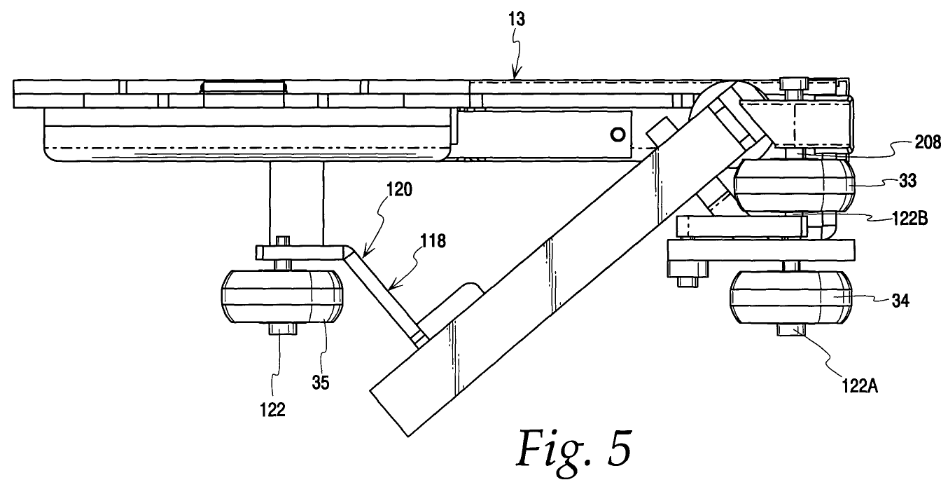

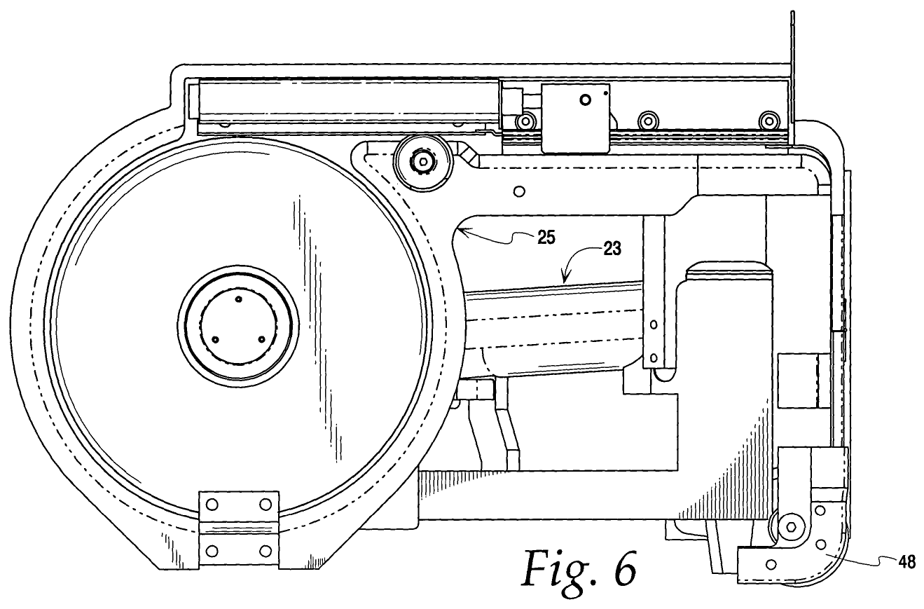

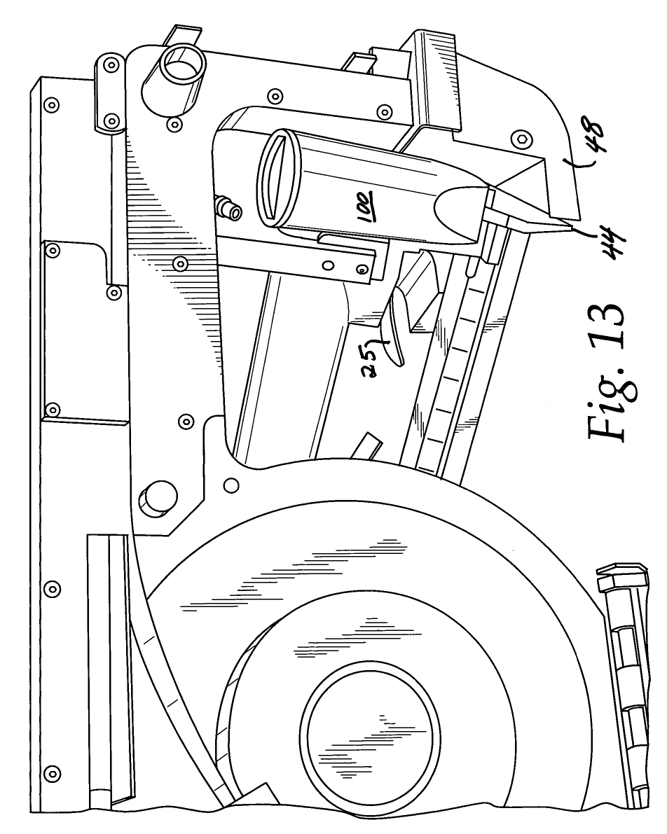

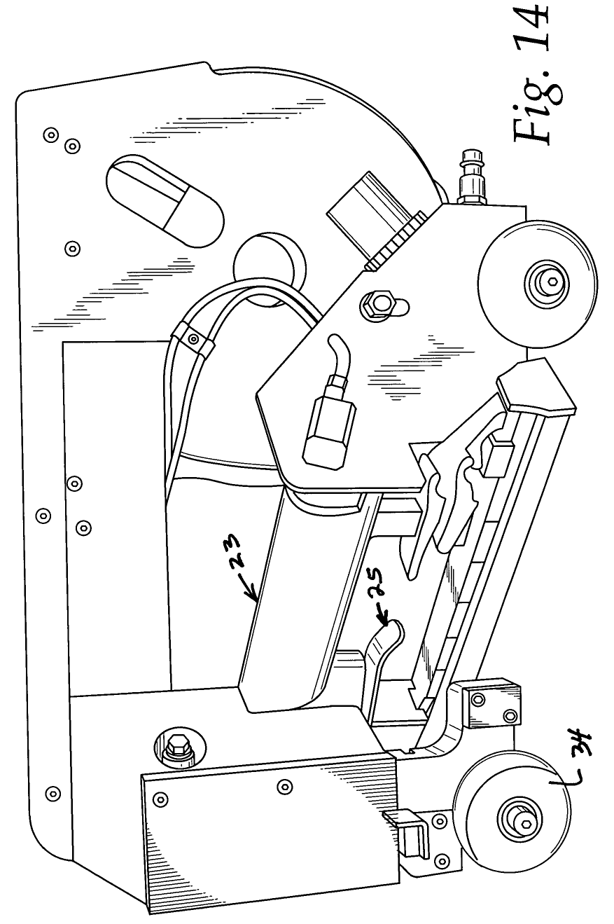

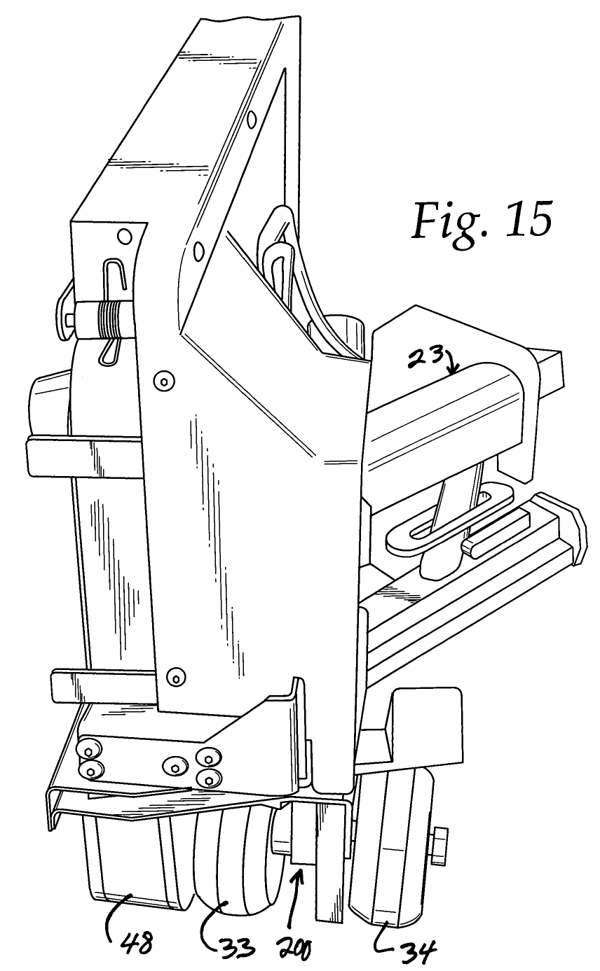

In the preferred embodiment of the invention, the carriage carries a safety device 27 that prevents applying a fastener such as a staple unless there is a concurrent or simultaneous operation of the safety device 27 and trigger 25 to operate the staple gun 22. In the FIGS. 1-12 embodiment, the safety device 27 engages the roof when the carriage is rocked toward the roof to the fastener applying position of FIG. 7A, and causes the safety device to operate and condition the fastener driving device for operation by the trigger 25 to fire the staple gun 22. As will be explained in connection with the FIGS. 13-20 embodiment, a safety device 227 is operated when the machine is first pressed against the roof prior to the initial rolling of the machine along the roof. In this first embodiment of FIGS. 1-12, the preferred safety device comprises a plunger 28 that is spaced from the roof by a predetermined distance, e.g., 0.100 inch when the plunger 28 is pushed through a distance of about 0.100 inches, a control air valve is actuated to allow air to be used to fire the gun and to staple the strip to the main roof. Thus, when the safety sensor is raised and the plunger is not depressed, an accidental pulling of the trigger 25 doesn't cause a firing of the staple as could injure a person because there was no preconditioning. Manifestly the safety device could be of other constructions, such as a lever that is pivoted or it could be a finger-actuated switch which is located adjacent the trigger 25 to be operated by a person who will use two fingers to operate the safety device and the trigger 25 simultaneously to fire the staple into and through the strip into the main roof 12 therebelow.

From an ergonomic standpoint the preferred machine 11 is wheeled to travel forwardly in a straight line while the user may lean on and push down against the handle 32 of the tool to support himself while pushing the machine forwardly along a straight line path as wheels 33, 34 and 35 on the machine roll forwardly in a straight line of travel much like that of a wheeled skateboard. Herein, the handle 32 is the handle portion of a commercially available staple gun and is located immediately, rearwardly of the vertically disposed, pneumatic cylinder 100 which is disposed vertically over the application point where the staple is applied to the strip. The handle 32 comprises the cylindrical magazine 42 containing the staples with the trigger 25 being adjacent the outboard side of the vertical, staple driving cylinder 100. The user will place his hand on the top of the magazine with the index finger on the trigger 25 and with the user's forearm aligned over the top of the magazine 42.

If a person is doing a duck walk across the slope of the roof and wants to support himself, the person would extend his forearm forwardly and down towards the roof at spaced locations and at an acute angle in the range of about 30° to 40° with a preferred angle being about 35°. When using the machine of this preferred embodiment, the person may do the same duck walk with his forearm extended forwardly and downwardly and his hand gripping the machine handle at an angle of about 35° to the longitudinal axis of the strip 22 being laid and to the usually horizontal edge 18 of the felting sheet. The person presses down on the machine and pushes the machine forwardly to roll along its wheels while the person walks along a path parallel to the felting edge 18. Thus, the person will experience less fatigue or physical strain because of the person leaning upon the machine at a good ergonomical angle.

The preferred wheels 33, 34 and 35 are those of the type that are used on skateboards or the like, which are heavy duty, plastic wheels. Usually the machine 11 will be used while on a sloped roof so that the person pushing on it is traveling along a straight line across the slope of the roof, i.e., horizontally, and it is preferred to balance the machine by having the staple gun magazine 42 of staples disposed outwardly and extending uphill at an angle with respect to the strip. On the other hand, the machine may be provided with an elongated handle, so that the person may walk upright when rolling the machine along the roof. The trigger 25 will be located in the handle.

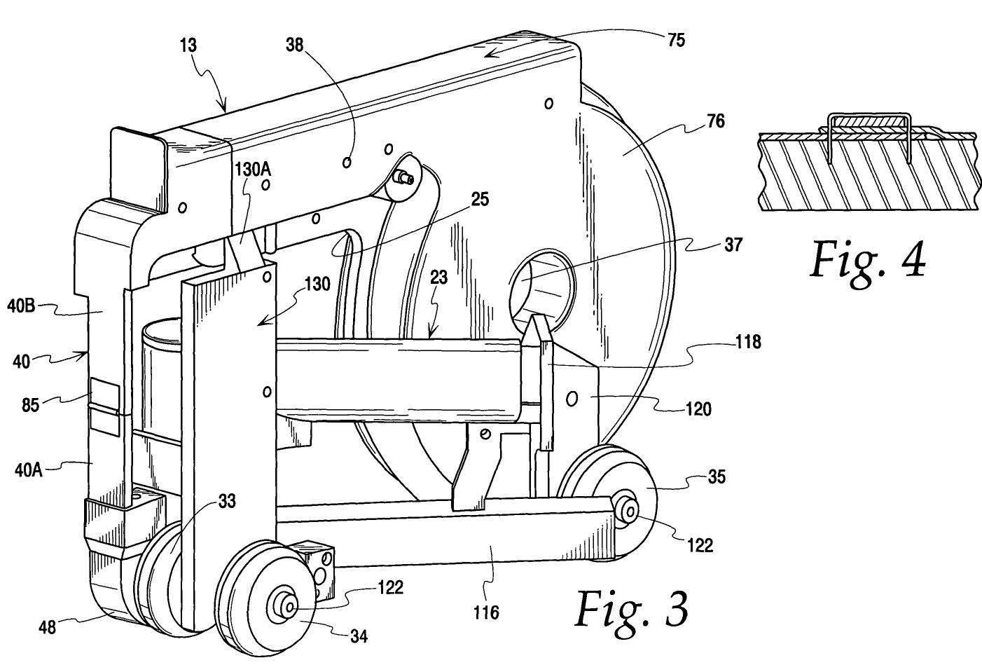

It will be appreciated that the strip 22 is a relatively thin piece of plastic preferably an extruded plastic having the properties previously mentioned above that is mounted on a reel 15 and that there is the need for applying the strip to the roof in a straight line with a quick, easy motion without the strip becoming twisted or otherwise skewed. To assist the strip in being laid in a straight line and to prevent its becoming skewed or twisted, it is preferred that the strip and reel be mounted in a substantially vertical plane with the reel rotating about a horizontal reel axis 37 (FIG. 3). In this preferred and illustrated embodiment of the invention, the strip is fed from the reel and travels in a common vertical plane without being twisted, bent or traveled sideways while changing directions. That is, the strip initially travels generally horizontally and forwardly from the reel 15 into and within an upper handle 32 of the machine and then travels downwardly within a strip guidance portion 40 and then travels horizontally and rearwardly to the staple application point 19 where it is laid on the roofing felt 10 as the machine 11 travels forwardly over the top of the strip, as best seen in FIG. 1. In this embodiment the strip is preferably unwound from the top of the reel and travels horizontally across from the rear of the machine towards the front of the machine through the interior of the hollow handle before turning downwardly at the vertical upper portion 40b. Thus, it will be seen that the strip from the time it is in the reel until the time it is applied and remains vertically aligned and in a substantially a vertical plane without ever being twisted in its travel and thus is easily guided and applied as it travels horizontally from the reel and downwardly in the strip guide 40 and then rearwardly to the application point.

When reaching the end of a felting strip as at one edge of the roof after having laid a strip 22 along one complete run of the roof 12, it is usually desired to sever this strip and to raise or lower the machine 11 along the slope of the roof to the horizontal edge of the next felting sheet and again start laying the strip 22 and fastening the strip with the staples 14 to the main roof 12. To this end, it is preferred to provide a severing device 50 which in this instance is a manually operated scissors 52 for severing the strip. Manifestly, a power actuated scissors device may be used. Also, other forms of severing devices may be used other than a scissors to sever the tape. Herein the severing device severs the strip several inches above the application point 19.

It is preferred that there be an automatic strip advancing device 60 which in this instance is in the form of a powered actuated cylinder 62 and pawl 64 which feeds the strip forwardly and downwardly from the severing device 50 towards the application point 19 upon actuation of the strip advancing device. As will be explained in greater detail hereinafter the preferred strip advancing device includes a fluid pneumatic cylinder 62 operable upon depression of a push button form of trigger 66 to shift the strip engaging pawl 64 forwardly to unwind a predetermined length of the strip material from the reel for example about 3 inches. Usually the operator will cause one or more actuations to advance about six or more inches of the strip in order to have a sufficient length of strip to place the leading end of the strip under the application point 19 in a position to be secured by staples 14. Rather than a powered strip advancing device, the strip advancing device could be manually powered. Also, an electric solenoid or other power device could be used rather than pneumatic cylinder to advance the strip. Thus, there is provided a simple and inexpensive device for feeding the strip to travel forwardly as needed.

In accordance with another aspect of the application, the fasteners 14 which are applied to the strip 22 are located at an acute angle to the longitudinal axis of the longitudinally applied strip because the staple gun is located at an ergonomical acute angle of 30° to 40° with respect to the edge of the felting sheet 10 and the longitudinal direction of the strip laid on the felting sheet. While the fasteners could be other kinds of fasteners, the illustrated fasteners are staples having two legs with a center span portion abutting the top of the strip. Herein, the staple legs are driven into and pierce through the strip with the center portion being at the acute angle to the longitudinal dimension or axis of the strip. In the present application, the staple is illustrated as also having the legs disposed outwardly of the side edges of the strip, i.e., without piercing the strip and with the spanning portion extending across the entire width of the strip. Thus, the staple may either pierce or not pierce the strip.

Referring now in greater detail to the illustrated embodiment of the strip applying and securing device 10, it comprises a plastic molded housing or frame 75 which as best seen in FIGS. 1, 2 and 3 includes a rearward rounded reel-shaped portion 76 which has a central opening at which is located a mounting hub 78 (FIG. 1) on which is mounted the wound reel or spool 15 of the strip 22. It is preferred that the wound strip reel be mounted on the hub 78 and be visible though a clear or transparent cover plate 80, as best seen in FIG. 2, which is hinged by hinge 82 at its lower connection with the housing frame 75 so as to be able to swing downwardly to a horizontal position to allow the insertion of a new reel of strip 22 onto the hub. The reel cover 80 allows viewing of the amount of strip still remaining on the reel so that the person using the reel can understand when a reel needs to be replaced. Herein, a viewing slot 81 is formed in the cover 80 and indicia 83 are provided on the cover in alignment with the outer edge of the roll of strip to indicate the amount of strip remaining in the roll. The reel cover 80 is locked in a vertical position retaining and covering the reel and combines with the molded reel cover portion 76 to contain the rolled strip which when full may contain about 800 to 1000 feet of the strip, as herein described above.

For the purpose of providing a smooth path for the strip 22 without any twists or turns which would cause problems in laying the strip or in the feeding of the strip smoothly, the reel 15 is mounted in a vertical plane with the strip 22 coming off of the top of the reel and into a strip guide plate 85 which is in the form of a flat plate disposed horizontally within the hollow handle 32. This strip 22 extends from the top of the reel across the horizontal guide plate 85 and past the pawl 64 of the strip advancing device 60 to a front curved portion 40b (FIG. 3) of a downwardly extending strip guide 40, as best seen in FIGS. 2 and 3. The vertical strip guide 40 is in the same vertical plane as the reel and in the same vertical plane as the strip as it travels across a top horizontal portion 75A of the machine as shown in FIG. 2. Preferably, strip guide includes a lower pivoted portion 40a which is mounted by a hinge 86 so that it may be swung upwardly and outwardly after the severing of the strip in order to allow a manual grasping of the newly formed leading end of the strip; and hence, the manual positioning of this new tape end into position for stapling to the roof.

In the embodiment of the invention disclosed in FIGS. 13-15, the application nose 44 of the staple gun slides along the strip underlying it with the application nose being separated from the roofing felt only by the thickness of the strip. The application nose holds the strip against the roof at all times and the staple gun is continuously enabled as the carriage rolls along the roofing felt so that the user is able to pull the trigger 25 at any time without any rocking of the staple gun down, as will now be described for the embodiment of FIGS. 7A and 7B. In this latter embodiment, the carriage rides along the roof on the wheels 33, 34 and 35 when it is in the strip applying position such as shown in FIG. 7B with the strip being laid onto the roofing felt at the application point 19 with a nose 44 of the staple gun and the safety device 27 being spaced by a gap or space 95 relative to the plane of the roofing felt 10 as shown in FIGS. 7A and 7B. By way of example only, the gap 95 is about 0.100 inches in the preferred embodiment of the invention, but the gap has been exaggerated in FIG. 7B to illustrate the point that the safety device 27 spaced above the roofing felt as the strip is laid until such time as the safety device is rocked from the strip applying position of FIG. 7B into the staple or fastener applying position of FIG. 7A where the safety device and the staple nose 44 are brought down into engagement with the top surface 96 or the plane of the roofing felt. Preferably, the nose 44 of the staple gun 22 is kept raised from the roofing felt by the gap 95 until it is desired to perform a stapling operation. When the machine 11 is rocked into the stapling position of FIG. 7A the staple gun nose 44 is pressing the strip tightly against the roofing felt, the plunger 28 of the safety device will have been pushed upwardly thereby conditioning the tool for firing upon pulling the trigger 25 to fire the gun.

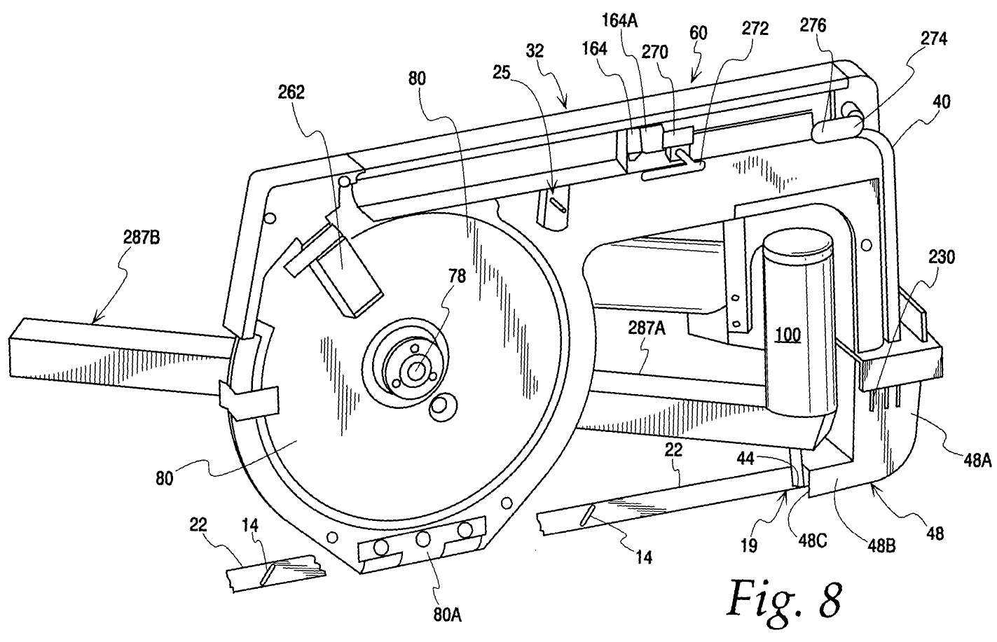

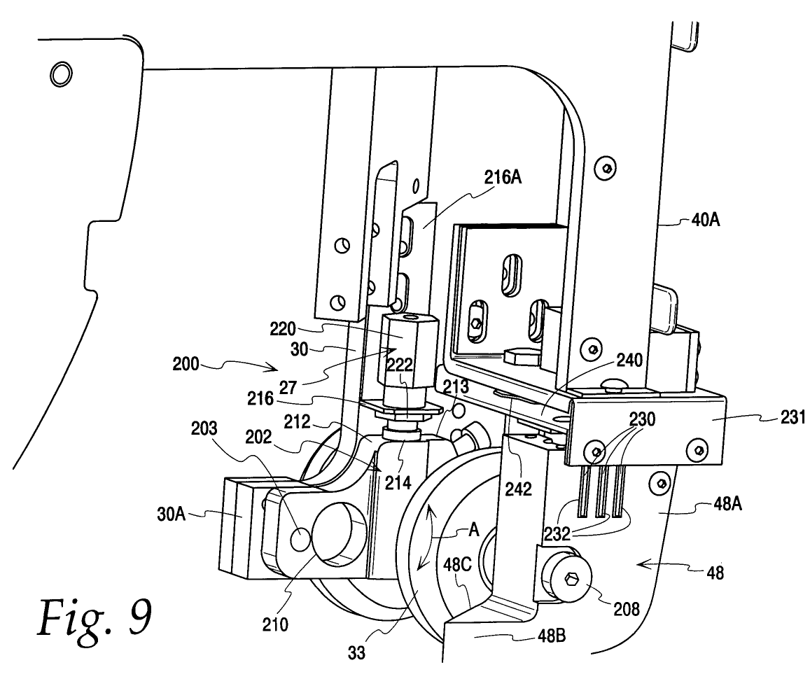

As best seen in FIGS. 8 and 9, the safety device 27 used with the embodiment of FIGS. 7A and 7B has its vertical plunger 28 with its lower end 99 which is spaced by the 0.001 inch clearance from the roofing felt surface 96 until in the stapling position of FIG. 7B. On the other hand when the machine tool 10 is rocked from the position of FIG. 7B into the staple applying position of FIG. 7A, the plunger 28 is pushed upwardly 0.001 inch and causes an enabling of the trigger mechanism 25 such that a depression of the trigger 25 causes the valves to allow the air flow to drive the stapler head cylinder 100 which is connected to the piston which is driven downwardly to drive the staple from the magazine into the strip.

The vertically disposed stapler head cylinder 100 is located adjacent the forward end of the device 10 and includes a conventional internal piston and projecting driver, which is attached to the piston for driving the leading staple from a staple magazine 42 through the nose 44 into the strip 22. While various power driven stapler devices may be used, the illustrated device is commercially available one from Senco Manufacturing Corporation. In the illustrated embodiment of the invention, the Senco fastening device lays the staples at an acute angle, e.g., about 35° to the strip axis, as best seen in FIG. 1 with the staples penetrating through the strip near the outer edges thereof but lying at an acute angle to the longitudinal axis of the strip. Preferably, the horizontally extending magazine 42 is disposed at the same acute angle to the strip and feeds the staples at the acute angle. The magazine with a load of staples therein provides a heavy weight or a mass located on the downhill side of the sloped roof and positioned between the front and rear wheels.

As best seen in FIGS. 1, 7A and 7B, the gun including the staple driving piston and cylinder 100 and the magazine 42 are supported by a lower horizontal mounting bar 16 and an upstanding right-angled portion 18 of a rear bracket 120. This rear bracket 120 has a vertical flat portion 120a positioned and located and secured to the vertical face of the rear wheel housing. This rear vertical bracket portion 120a (FIG. 1) also mounts a horizontally disposed stub axle 22 onto which is journaled for rotation the rear wheel 35 as best seen in FIGS. 1 and 3.

It is preferred that the staple gun be easily attached and detached to the mounting bar 16 and rear bracket 120 so that it can be easily removed for service or replacement with the same kind of fastener gun or with a fastener gun of another kind or from another manufacturer.

A front supporting bracket 130 is provided at the front of the machine and is attached at its upper end by a portion 130a to adjacent the front handle portion of the housing and includes a lower portion which mounts horizontally disposed stub axles 22a, 22b for the respective front wheels 33 and 34 to rotate around horizontally disposed axes through their respective stub axles 22.

To advance the strip and actuate the automatic strip actuating and advancing device 60, the user operates the push button trigger 66 to cause the fluid to flow into a horizontally disposed pneumatic cylinder 62 (FIG. 2) which is disposed between the strip guide plate 85, as best seen in FIG. 2 and the top surface of the handle 32 of the machine housing. The cylinder 62 extends forwardly from the top of the reel and at the rear of the handle to a forward bracket 164 which supports a forward end of the cylinder. The cylinder has a piston rod 165 which extends through the bracket to the pawl 64 which is adapted to be pivotally mounted to point about an axle 168 for engagement with the top surface of the strip to feed the strip forwardly as the piston rod is moved outwardly of the cylinder 62 for about 3 inches in travel toward the front guide 140. A bracket 170 mounts the pawl and guides the pawl for travel in a rectilinear motion as it travels to feed the strip forward. Usually, the push button switch will be actuated at least twice to move about six inches of the leading end of the tape of more downwardly from the severing device to bring it underneath the staple driver which is then actuated to staple the leading end of the strip as a new run is being made across one of the felting sheets to secure it to the underlying main roof.

In accordance with the further embodiment of the invention which is shown in FIGS. 8-12, this further embodiment differs primarily from the above-described embodiment in that the outer wheel 33 and the safety device 27 are mounted on a pivotally mounted head 200 that includes a head support 202 which is pivotally mounted to turn about an axle 203, as shown by the directional arrow and as best seen in FIG. 9. This pivotally mounting of the wheel 33 and the safety device 27 allows the wheel to be moved upwardly about the pivot shaft 203 when the tool is placed down on the roof and the wheel is automatically raised with a spring being compressed and the safety device 27 which has an internal air valve or switch being activated, i.e., opened to let air flow into the trigger which can now be operated to fire a staple into the strip. Thus when the device is placed on a roof and the operator begins to roll the device along the roof, the operator does not have to tilt the machine between the positions shown in FIGS. 7A and 7B, as in the previously described embodiment of the invention. Instead the operator will be able to pull the trigger and apply a staple so long as the pivotally mounted wheel 34 and safety device 27 are kept in the upper raised position. When laying the strip, the stapler nose will be kept just above the roof by the pair of front wheels 33 and 34 so that the stapler nose 44 is not digging into the roof and so that the device rolls easily along the roof. In addition to the wheel and the safety device being mounted on the moveable head 200, the lower, elbow-shaped, tape guide 48 is also mounted on the moveable head 200 and it raises and lowers as the lever head pivots about the axis 203. At the time of stapling, the operator will press downwardly on the nose of the stapler head and the front of the machine causing the nose to move downwardly approximately a 1/16″ or so and this extra downward pressure presses the nose of the stapler tightly against the strip and holds the strip tightly against the roofing felt at the time the trigger is pulled so as to provide a good stapling of the strip to the roof. It is undesirable to have the strip loose, i.e., not engaged with the roof at the point of stapling and at the time of application of the staple because a loose strip does not provide as good a stapling of the strip to the roof. After the stapling action, the operator will let up on the nose pressure so that the nose can rise and then the operator will continue to roll the device along to the next stapling location. As the operator walks along the roof, some of the operator's weight is leaning on the tool and again when it is desired to provide the next stapling, the operator will then push the nose downwardly to cause the wheel 33 to move upwardly slightly and to cause the tape guide 48 also to move slightly out of the way so that there is no interference as the nose of the stapler staples the strip to the roof.

Turning now in greater detail to the preferred construction of the pivotally mounted head 200, it carries the floating wheel 33, the safety device air switch 27 and the elbow-shaped tape guide 48 on a head support 202 which is mounted on the axle 203 of which is carried by the front supporting bracket 30. This front supporting bracket 30 still has the axle 122a which is mounted at the same position and in the same manner as in the above-described embodiment invention of FIGS. 1-7. The floating wheel 33 is mounted on an axle 208 as best seen in FIG. 9, which also carries the elbow-shaped tape guide 48 with the axle 208 being mounted on its inner end in the head support 202. The axle 208 is co-axial with the axle 122a when the device laying the strip on the roof and moveable head 200 is in its upper active position. However, when the device is lifted from the roof, the axle 208 and wheel 33 will be displaced downwardly to an inactive position for the head 200 with the wheel axle 208 no longer co-axial with the axle 122a.

The head support 202 as best seen in FIG. 9 has a rearward end mounted on the axle 203 which is carried on a horizontal lower extension 30a of the vertical mounting bracket 30. There is a large hole 210 in the lever adjacent the axle 203. An upper side 212 of the head support 202 has a top horizontal surface 213 against which it is seated a lower and of a vertically extending plunger 214 of the air switch 27 which is mounted thereabove by a bracket 216 to the front supporting bracket 30. The upper portion of the air safety device 27 has a connector 220 to connect to an air line (not shown) in FIG. 9 and is mounted and positioned and held in place by a lock nut 222 relative to an underlying, supporting horizontal, stationary bracket 216. The stationary support bracket 216 has a vertical portion 216a which is adjustably fastened to a vertical sidewall of the vertical mounting bracket 30. A biasing spring within the air valve device 27 biases the air switch plunger 214 into contact with the top surface 213 of the upper side 212 of the head support 202. The air switch plunger 214 moves vertically within an interior bore within the air switch device 27 to open and close the same as the head support pivots downwardly or upwardly about the axle 203. When the machine is removed from the roof, the spring (not shown) within the air switch and the latter pushes the head support downwardly; and also pushes the plunger 214 downwardly, the weight of the wheel 33, the elbow guide 48 and the axle 208 causes the head support and the wheel 33 to pivot downwardly to a certain extent which is limited by a stop (not shown). On the other hand when the device is placed on the roof and the floating head support 202 and wheel 33 are pushed upwardly by the roof relative to the rest of the gun and swings the head support 202 in a counter-clockwise direction as seen in FIG. 9. As a consequence, the plunger 214 will be pushed upwardly to open the air switch device 27 to allow air to flow to the trigger. Thus, the air switch device is conditioned upon setting of the wheel 33 on the roof to allow a stapling action, whereas when the device is lifted from the roof, the trigger is disabled from causing a discharge of a staple as could strike and injure a person.

The tape guide 48 is elbow-shaped and has a upper portion 48a as best shown in FIG. 9 and a lower horizontal portion 48b with an inclined end face 48c which is inclined at the acute 35° and is positioned against or adjacent to the stapling gun nose. It is preferred that the tape guide 48 experience and be guided by three vertical plates 230 which are mounted in slots 232 in the guide which is preferably made or a plastic material such as Delron. Herein the three plates 230 are thin stainless steel plates fixedly mounted to a stationary bracket 231. The three plates 230 fit loosely within the slots 232, which are vertically oriented, to allow and to guide the tape guide 48 to shift relative to the staple nose as the head 200 is pushed downwardly to do a stapling action at the time the trigger is to be pulled. The three plates 230 slide in the slots 232 to guide the tape guide when the device is removed from the roof and the guide 48 and the wheel 34 swing downwardly. The three plates 230 thus assist in guiding the guide 48 to an out of the way position for the stapling action to allow the staple to issue from a bottom slit in the bottom of the nose of the stapler. Thus, it is possible to guide the tape downwardly to the point of stapling at which is located the inclined face 48c of the guide 48. But when there is a stapling action, the staple face must be allowed to contact the tape and the guide head and 48c is shifted out of the way to allow the stapling action to occur. Thus there is a complete guide of the strip through the hollow interior of the tubular plastic elbow-shaped guide 48.

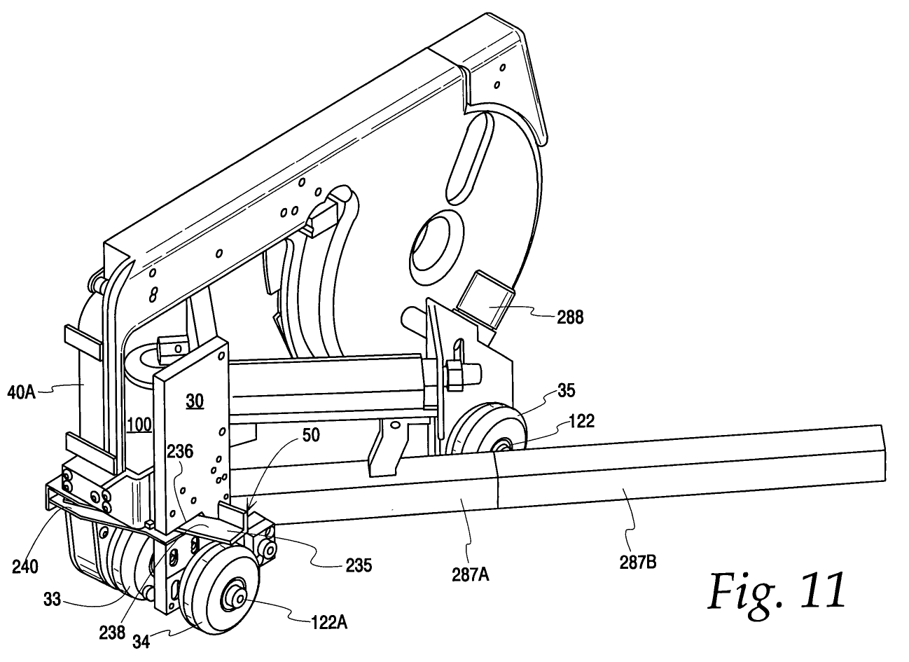

When the device is moved along the roof to an edge or end of the roofing felt, the operator of the device will want to operate the severing device 50 to sever the strip before starting a new reverse run of strip laying and stapling of the new strip to the next edge of the felting material. As best seen in FIG. 11, the severing device employs a lever blade 235, which projects outwardly from a slot 236 in the front upstanding support bracket 230 and which has inner cutting end which extends horizontally across to a location where the strip is positioned between the upper strip guide portion 40a and the lower elbow-shaped portion 48. The preferred scissoring action is accomplished with only the single movable lever blade 235 which is pivotally mounted adjacent the bracket 30 by a pivot pin on a bracket support with the severing portion 238 of the severing device 235 being horizontal and being located to slide along a fixed anvil plate 240 on the bracket 242 which is attached to the front plate and is horizontally disposed. The fixed anvil plate has a slot therein through which the tape passes and travels downwardly into the lower tape guide 48. The severing blade 235 lays on and rests on the anvil blade plate. It is preferred that the scissor action start at one edge of the strip and then progress across the width of the strip to the opposite strip edge. Thus, there is a scissoring from one longitudinal edge across the strip to the other longitudinal edge rather than trying to cut the entire strip simultaneously. A torsion spring 242 (FIG. 11) is mounted on the horizontal, stationary bracket and biases the severing blade to its open position whereby it is spaced from the strip. Manifestly, the use of the severing device 50 is optional and need not be provided, although it provides a very useful way for quickly cutting the strip without having to use an additional tool. Manifestly, the severing device can take various forms and shapes from that disclosed herein. The lever blade 235 and anvil plate blade 240 are made of stainless steel blades to provide an inexpensive and long wearing severing device. The components can be easily replaced if something should happen to them. Finally, the severing device is inexpensive and is located at a position where it is out of the way with the rest of the machine which is a compact device.

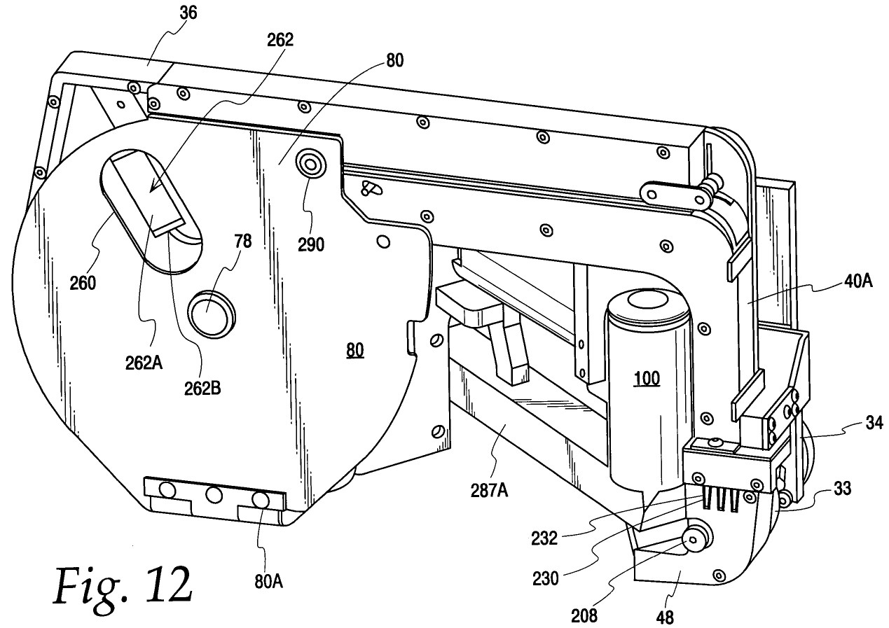

Referring now in more detail to the strip guidance and advancement of the strip from the reel, the reel containing the long, coiled strip is mounted at the rear of the device within the wheel housing 75 that includes the hub 78 and the pivotally mounted reel cover 80 which is pivotally mounted by hinges 82 on the lower side thereof to the main support, as seen in FIG. 12. In the embodiment of FIG. 12 the reel cover 80 is provided with a viewing slot or opening 260 to reveal an internal spring clip 262 which is of U-shaped configuration to receive a portion of the coil between the legs of the U-shaped clip. As the reel is inserted, the outer leg 262a of the spring clip 262, as shown in FIG. 12, is pushed outwardly relative to the inner leg with the reel being gripped by the outer spring leg 252a against the inner leg. The outer leg 262a has an upturned end 262b as best seen in FIG. 12 so that it will not catch on the reel when it is being inserted into the device with the thickness of the coil being greater than the spacing between the inner and outer legs at the entrance end 262b therebetween. Thus, the coil pushes the outer leg 262a outwardly to allow passage interiorly of the coil between the spring legs which are then spaced apart a distance which is slightly greater than the width of the coil. The end 262b of the spring arm 262 grips the coil and exerts a resistance to an unwanted rotation of the reel that would result in a loose strip or a partially unwound coil of the strip. Thus, the spring acts as a slight brake on the reel that is overcome as the strip is pulled from the reel. Further, the spring guide prevents the reel or coil from popping out before the cover is closed. Also, the upper U-shaped end of the clip holds the outer turn of the coiled strip from unwinding and moving radially outwardly.

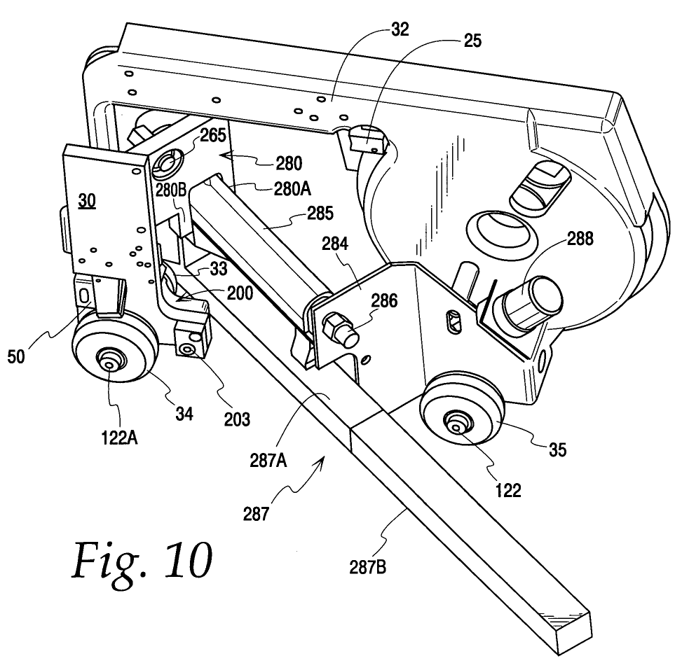

In accordance with the present invention, the spring clip 262 combined with the other features of the strip guide wants to provide a complete guiding of the strip from the reel down onto and to the stapled portion of the strip on the roof. The movement of the machine forwardly causes a dragging of the strip from the top of the reel which is being held with some gripping and frictional force by the outer leg 262a of the spring clip but which allows the coiled reel to turn about the hub 68. As best seen in FIG. 10, operation of the strip feeding push button causes a strip advancing device 60 (FIG. 8) to cause air to be moved into the cylinder 162 pushing the piston rod 164 from the cylinder and to push the wedge-shaped pawl to swing down about its pivoted connection pin 270 with a fork 164a on the distal end of the piston rod. Because the strip 19 is a plastic and rather slippery, the pawl pushes the strip downwardly against a backing support 272 which is mounted for horizontal, rectilinear travel beneath the strip. Thus, the strip is gripped between the pawl and the back support 272 when the pawl is pushed forwardly by the piston rod 164. When the air cylinder pulls the piston rod and pawl rearwardly, the back support is also pulled in the reverse direction. When the piston rod travels rearwardly, it swings upwardly about the pivot connection pin thereby releasing its grip on the strip. The grip is only applied again at the next operation of the push button 265 and extension of the piston rod from the cylinder. Herein the stroke of the cylinder and the strip feed is about 2.5 inches, which manifestly can be varied.

After severing the strip 19 with the severing action, the operator will depress the push 265 one or more times and will swing the upper portion of the vertical strip guide 40 outwardly about its upper pivoted end. The operator will grip the strip and insert through the slot in the anvil plate and into the hollow interior of the lower elbow-shaped strip guide 48. With several actuations of the push button the threaded strip will have exited the inclined end 48c of the guide 48 at the nose of the staple gun. Thus, the swinging move of the vertical guide 40 outwardly allows the easy threading of the strip down, through and past the nose 44 of the stapling gun to a location where an operator may then place the machine against the roof and cause the floating head 200 to raise, as the wheel 33 moves upwardly, and to condition the switch safety device 27 to allow a pulling of the trigger for the first stapling of the strip to the roofing felt, as a new run has begun.

From the foregoing it will be seen that there is a complete guidance of the tape strip, and that the strip never is left without guidance and that the strip is not twisted as may cause problems by bending one edge more than the other edge. While it is true that the strip does travel forwardly, travel downwardly and then rearwardly, nonetheless the changes in strip travel direction are made without having to bend the strip sideways as would cause one edge of the strip to be moving through a greater or shorter distance than the other edge as may cause problems.

The preferred embodiment of the invention also mounts the stapling device and machine at its front portion by a yoke 280 which is secured to the vertical supporting bracket 30 as best seen in FIG. 10 and has a lower yoke-shaped portion formed by legs 280a and 280b on opposite sides of the main portion of the stapling device. The rear end of the stapling device is supported by a rear vertical bracket 284 which has an air fitting 286 to supply air to the rear of the stapling device cylinder 285 as shown in FIG. 10. This rear bracket also supports the rear axle 122, the rear wheel 35, and air connection fitting 288 to be connected to a compressed air line (not shown). It is preferred to provide an extra long magazine 287 having a first usual forward portion 287a to which is added another longer extension portion 287b to provide a large capacity of staples for the staple gun. If something should happen to the staple gun, it can be easily detached from the brackets 280 and 284 and another be positioned in its place. Or a different type of stapling device may be used or some other device may be applied which is not a stapling but uses other types of fasteners.

From the foregoing it will be seen that there is a unique stapling of the strip with an ergonomic positioning of the hand and arm at about a 35° acute angle in the preferred embodiment to the longitudinal edge of the roofing felt and that the staples are being applied to the strip at this acute angle for holding the strip to the roof. The action is merely supporting yourself as leaning towards the roof and rolling the device along and just tilting the nose downwardly for about a ⅙″ to put more pressure on the nose so that the nose of the stapling gun is holding the strip tight against the roofing felt along the trigger is pulled. Then the operator will let the nose up slightly and roll the device along the roof still keeping weight on it and leaning on the device as the operator continues to duck walk along the roof and stapling the strip to the roofing felt and to the roof. The wheels track straight across the roof so that it is easy to parallel a straight horizontal edge of the roofing felt material. The device can be laid down at the roof at any time. One or more rubber bumpers 290 as shown in FIG. 12 may be provided on the cover or on the side of the device to prevent it from sliding down the roof.

The preferred and illustrated embodiment of the invention weighs only slightly over ten pounds with the tape of the strip alone accounting for 7 or 8 pounds of the weight. Thus it is provided a very light weight tool for laying quite a bit of strip.

In the embodiment illustrated in FIGS. 13-15, the lower strip guide 48 and nose 44 of the staple gun are always down and there is no need to try to rock or to press the front end of the device downwardly to force the strip tightly against the roofing felt before pulling the trigger to staple the strip to the roofing felt. Instead, the front wheels 33 and 34 and the rear wheel 35 are mounted on the carriage such that the strip being laid onto the felt and under the nose 44 of the staple gun is pressed tightly against the roof. There is no rocking movement, as in the FIGS. 1-7 embodiment and there is no depression of the front end about 1/16″ inch as described for the FIGS. 8-12 embodiment.

In the FIGS. 13-15 embodiment, the outer wheel 33 is mounted on the pivotally mounted head 200 to swing about the pivot shaft 203 to operate the safety air switch 27, as described about in connection with the FIGS. 8-12 embodiment, to enable or condition the staple gun such that pulling of the trigger causes air to flow into cylinder and to push downwardly the piston and staple driver (not shown) to drive a staple into the strip to fasten the strip which is already being held by the staple gun nose 44 against the roofing felt. Thus, in the FIGS. 13-15 embodiment, the staple gun is disabled when lifted from the roof and the outer wheel 34 and pivot head 200 swing downwardly and is enabled when the wheel 34 and pivot head are swung upwardly to enable the safety switch as the carriage is rolled along the roof. Any pulling of the trigger 25 while the safety switch is enabled immediately fires a staple to apply it to the strip without any rocking as in th FIGS. 1-7 embodiment or a further depression of the front end of the device, as in the FIGS. 8-12 embodiment.

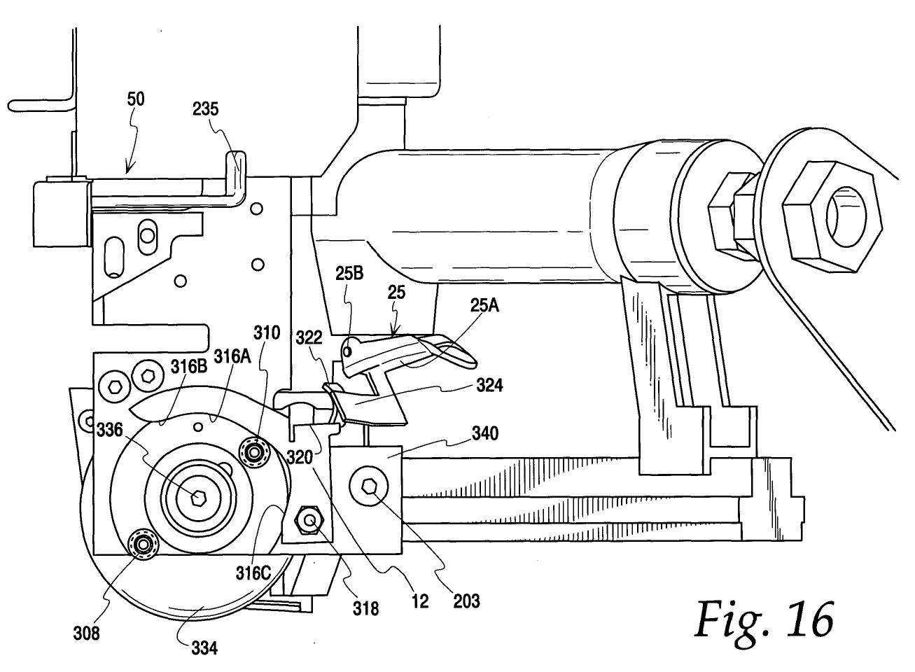

In accordance with the embodiment illustrated in FIGS. 16-21, the apparatus is provided with an automatic firing or actuating mechanism 300 which automatically fires the staple gun 23 at predetermined intervals along the strip without having to manually pull the trigger 25. That is in many instances it is desired to have the operator walk as quickly the operator can walk along the roof while laying the strip and to have the fasteners or staples 14 automatically driven by the tool into the strip at equally spaced distances or centers along the strip. For example, for a close pattern of staple driving at small intervals, staples may be driven every 3 or 4 inches and for larger spacings the staples may be driven 8 to 10 inches. Of course, the invention is not limited to any particular spacing of the staples as this spacing may be varied from that described herein by way of example only.

Herein the automatic firing mechanism can be enabled or disabled. When disabled, the operator will manually pull the trigger 25, as best seen in FIG. 16 to rotate about the trigger lever about a pivot pin 25b in an upward direction to cause the firing of a staple into the strip and into the roofing felt. The particular staple guns have a respective operating cycle that cannot be exceeded in that it takes a certain amount of time for the staple to be driven down fully into the strip and for the driver and actuator to return upwardly from the lower driving position and for a new staple to be fed into position for driving, particularly whether there is a pneumatic operation of piston which must perform both a downward and upward travel.

In accordance with the preferred embodiment of the invention, the measuring of the spacing between staples is accomplished by a measuring roller or wheel 334 that serves both as a wheel to support the rolling carriage and serves as a measuring means in that it has a circumference that is related to and a function of the spacing between staple applications to the strip. In the embodiment illustrated and described in FIG. 16, the measuring roller 334 has a circumference of about 8 inches and it can apply a staple every 8 inch revolution or in the case of the illustrated embodiment, apply a staple every 4 inches every half revolution because there are two cam actuators or camming pins or inserts 308 and 310 associated with the wheel, each of which can cause a staple application to the strip, as will be described in greater detail hereinafter. The camming pins 308 and 310 and measuring roller 334 are part of an actuator device 312 which is used for the automatic fire mechanism to cause the application driving of the staple at the predetermined intervals in an automatic manner without a manual pulling of the trigger 25.

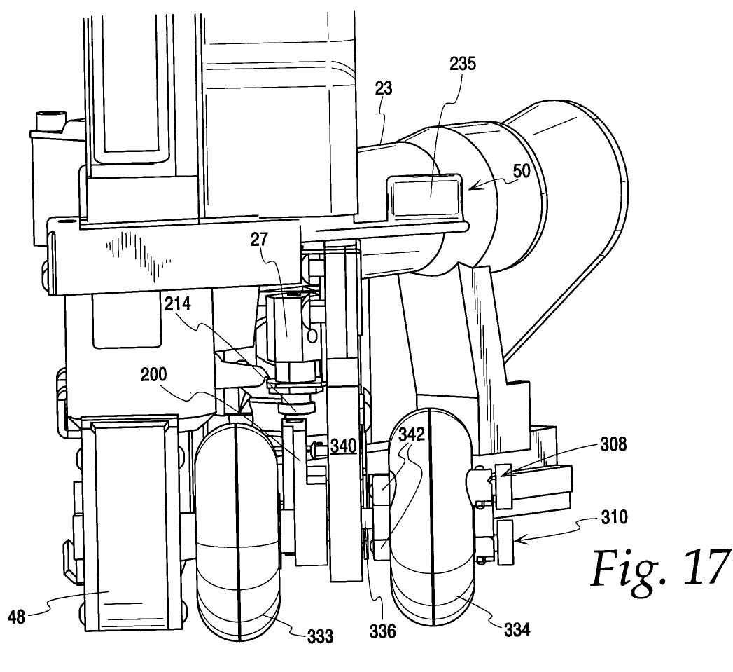

The preferred and illustrated actuator mechanism 312, which is shown in FIGS. 16 and 17, has a pivotally inserted actuator 316 with a long cam surface 316a therein on a first arm thereof. The cam surface is engageable with and cammed by one of the actuator pin 308 or 310 to pivot about a pivot bearing 318 for the actuator. More specifically, when a pin 308 or 310 engages the cam surface 316a at a beginning point 316b and rotates to the position shown in FIG. 16 about half way through its actuating cycle, the actuator 316 has swung about the pivot bearing 318 in a clockwise direction. As best seen in FIGS. 16 and 17, the actuator 316 has an integral offset second arm or cross piece 320 bent at a right angle to the cam carrying arm and then has a bent upwardly extending arm or trigger camming finger 322 on the cross piece 320. The trigger cam finger 322 is bent and curved to serve as a cam to engage and push the depending appendage 324 on the trigger 25. The trigger 25 of the staple gun has been modified to have the bent integral appendage piece which is appended to and depends from the trigger body 25a as shown in FIG. 16. Thus, as the pin 310 engages the cam surface 316a and pivots the actuator 316 clockwise about the pivot bearing 318, the integral, upstanding cam trigger finger 322 on the actuator 316 is engaging and pushing against the trigger appendage 324 which is aligned with the finger to pivot the trigger 25 upwardly to the position shown in FIG. 16 causing the firing operation.

This firing operation is preferably held for a considerable period as the length of the cam extends from 316b to ending at 316c for about 140° to 150°. This particular cycle is sustained long enough for the staple to have been applied and for the piston to have returned and for a new staple to be fed into position from the magazine such that the stapling gun cycle has been finished before the other actuating pin 308 arrives at the beginning of the cam 316b to initiate another gun firing cycle to apply another staple at a 4 inch interval. The appendage 324 was added to the bottom of the trigger 25 and is used with the automatic cam actuating mechanism as above described. If the automatic firing mechanism 300 is disabled, as will be explained in greater detail hereinafter, the manually operated trigger 325 is operated in the usual manner with the person placing one or two fingers on the trigger 25 and pulling upwardly on the trigger to pivot it in a counter-clockwise direction about the trigger pivot pin 25b to the position shown in FIG. 16.

From a safety standpoint, the air safety switch 27, as shown in FIG. 17, has its depending plunger which is adapted to be pushed upwardly, as in the manner herein described before, by an actuator finger on the pivot head 200 which functions in the manner of the pivot head 200 described above except that it is now the measuring roller wheel 334 that is mounted by an axle 336 on the pivot head 200 for pivoting the pivot head upwardly and downwardly. When the tool is placed on the roof for actuation, the pivot head 200 is shifted by the wheel 334 contacting the roof to swing the pivot head 200 upwardly to engage its actuating portion 212 with the plunger 214 of the air safety switch 27 to push it upwardly to allow air to flow into the staple gun such that a pulling of the trigger allows air flow to drive the piston and a staple with operation of the trigger. Conversely, when the tool is lifted from the roof and when the pivot head 200 and the measuring wheel 334 are allowed to drop downwardly under their own weight and a spring return, the plunger is spaced from the actuating portion 212 of the pivot head 200 and the air supply is to be disabled so that if there is a pulling of the trigger, there will be no actuation of a staple as could injure someone. In order for the gun to be fired by the automatic firing mechanism 300 while the gun is lifted, it will be necessary to simultaneously push the wheel and the pivot head 200 upwardly and to rotate the measuring wheel 334 to bring one of the camming pins 308 or 310 around through a camming operation. This dual action requirement provides a safety feature which should prevent any inadvertent operation of the tool when it is lifted from the roof.

The print head 200 also carries the tape guide 48 which is constructed and operates as in the hereinbefore described embodiment such that the wheel 334 and tape cycle 48 move in unison and the pivot head 200 pivots about the pivot bearing 203. Except for the automatic firing mechanism, the embodiment of FIGS. 17-20 is constructed and operates in a similar fashion as described for the previously described embodiment of FIGS. 8-15.

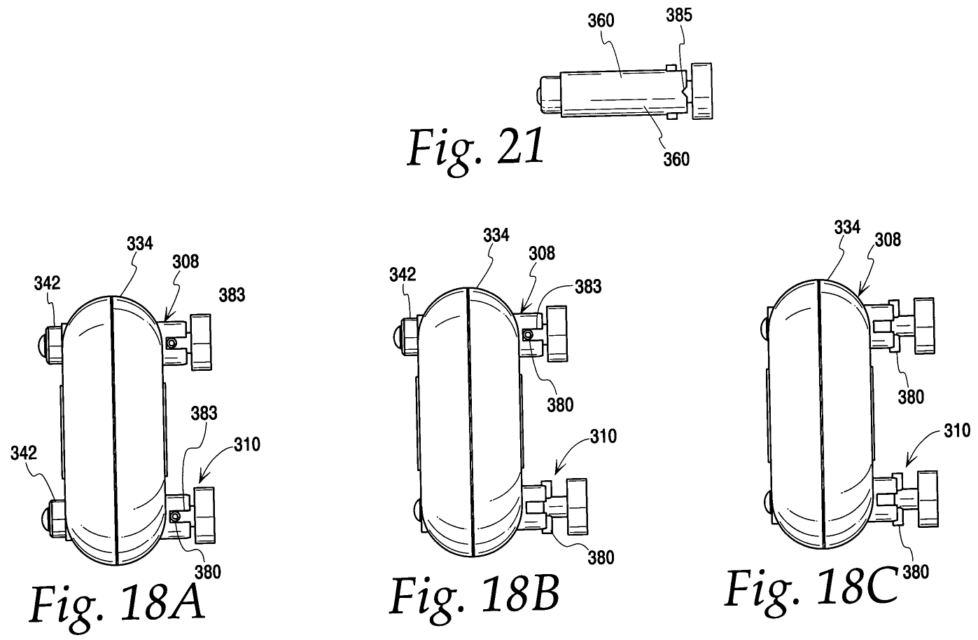

The camming pins or inserts 308 and 310 are identical in construction and they may be positioned to provide three different operations, as shown in FIGS. 18A, 18B and 18C for their three different operative positions. In FIG. 18A both of the camming pins 308 and 310 are in the operative position with their respective left ends, on which is carried a roller 342, disposed outwardly of the left side of the measuring wheel 334 and positioned to engage and to push the cam surface 316a. The measuring roller wheel 334, as shown in FIG. 18B, with only the upper pin 308 being in the operative/engaging position and with the roller pin 310 the roller having been retracted to the non-engaging position. That is, as seen in FIG. 18B, only the upper roller 342 for the pin 308 is positioned to engage the cam surface 316a when the measuring wheel rotates through 360°. When only one actuating pin, either 308 or 310, is in the operative position, the automatic firing occurs every 8 inches of travel of the carriage with 8 inches of tape being laid down between staples. Thus, the tape will be fastened by fasteners such as staples at 8 inch centers along the length of the roofing felt. On the other hand, where both pin 308 and 310 are in their operative positions as shown in FIG. 18B, a staple fastener is applied every 4 inches of travel of the tool and every 4 inches of the strip being applied to the roofing felt.

The auto-firing mechanism will be disabled so that the staples are fired only by manually pulling the trigger upwardly as viewed in FIG. 16 when both of the pins 308 and 310, as shown in FIG. 18C, are in their retracted positions such that neither projects to the left of the roller wheel 334 so as to be in position to engage the cam surface 316a and to pivot the actuator mechanism to engage and pivot upwardly the appendage 324 of the trigger 25. Thus, the device may be enabled or disabled and may be enabled to apply staples every 4 inches or twice in a revolution of the measuring roller 34 as illustrated in FIG. 18A or to apply one staple per one revolution of the rotating measuring roller 334 with only the actuating cam pin 308 being operative as illustrated in FIG. 18B.

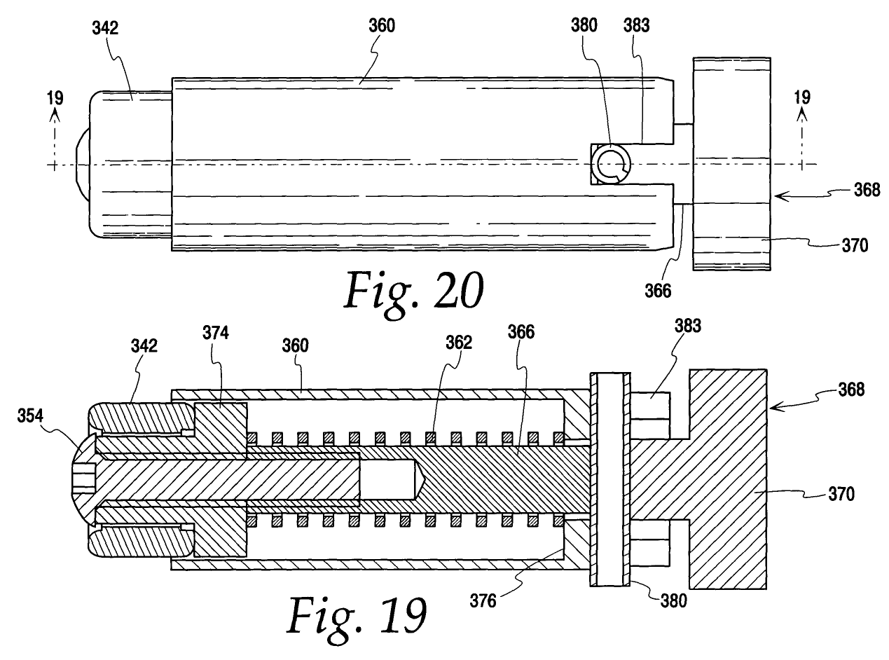

The illustrated indexing pin or cam pins 308 and 310 are preferably constructed as seen in FIGS. 19-20 with a cylindrical, hollow outer housing or bushing 360 that is positioned within a bore drilled in the indexing or measuring wheel 334 and is preferably glued therein. The index bushing 360 is hollow as shown in FIG. 19 and has within its interior a preload spring 362 having one end pushing the bearing roller 342 to the left to the operative position to engage the cam 316a. The bearing roller 342, which can be a needle bearing, is mounted between a button head having an outer end 364 adjacent to and holding the outer end of the bearing roller 342; the button head and has a inner end threaded into a inner cylindrical shaft 366 of an elongated stem 368 that has an outer cross head or outer head 370 exterior of the bushing 360. An inner side of the bearing roller 342 bears against a shoulder nut 374 against which also bears the left end of this preload spring 362. This preload spring engages a right hand end wall 376 in the hollow bore in of the bushing 360 and is compressed to urge the stem 368 to move to the left as in FIG. 19. When the roller 342 is in the operative position, a roll pin 380 carried by the stem is positioned within the deep groove or slot 383 in the right end wall of the bushing 360 is shown in the FIGS. 19 and 20. FIG. 21 shows another shallow V-notch 385 in the end wall 360a of the bushing 360 which notch is located at 90° from the deeper roll pin slot 383. The notch 385 has a very shallow depth, as illustrated in FIG. 21 as compared to the deep slot 383. Thus, when the stem 368 is pulled to the right as viewed in FIG. 21 against the pressure of the spring 362 and is rotated 90°; the roll pin 380 may be placed in the notch 385 and the bearing roller 342 will be retracted to the right and sufficiently into the bushing 360 such that the roller 342 will be in the inoperative position where it cannot engage the cam surface 316a to pivot the actuator 316 to operate the trigger 25 as the measuring wheel turns.

Turning now to FIG. 18A, it will be seen that the stems 368 are each positioned with its associated roll pin 380 in a deep groove 383 with both of the cam pins 308 and 310 in their operative position. In FIG. 18B the upper pin 308 has its roll pin 380 in the deep slot 383 so that its bearing roller 342 projects outwardly from the left end of the pin bushing 360, whereas the lower cam pin 310 has its roll pin 380 positioned in the notch 385 with the bearing 342 being retracted into the left end of the pin bushing and being inoperative for engagement with the cam surface 316a. In the illustration of FIG. 18C, both of the cam pins 308 and 310 are in their inoperative positions with the roll pin 380, for each of their stems being in the shallow notch 385.

Thus, it will be seen that there is a simple and inexpensive auto-firing mechanism. The preferred auto-firing mechanism is made with stainless steel parts that will not rust and which will have a long wear life and the ability to withstand heavy operations and abuse such as being thrown about in pickup trucks and the like as needed for roofing uses and handling by contractors who do roofing jobs.

This application—taken as a whole with the abstract, specification, claims, and drawings being combined—provides sufficient information for a person having ordinary skill in the art to practice the invention as disclosed and claimed herein. Any measures necessary to practice this invention are well within the skill of a person having ordinary skill in this art, after that person has made a careful study of this disclosure.

Because of this disclosure and solely because of this disclosure, modification of this method and device can become clear to a person having ordinary skill in this particular art. Such modifications are clearly covered by this disclosure.

What is claimed is:

1. An apparatus for stapling a plastic strip along an edge of a roofing felt to an underlying roof support comprising:
a wheeled carriage for rolling along a path parallel to the edge of the roofing felt;
a reel of the strip being mounted to the wheeled carriage for supplying the strip to the roofing felt as the strip is unwound from the traveling wheeled carriage;
a power driven staple tool having a supply of staples and a powered driver for driving staples into the strip, the roofing felt and the underlying roof support;
the power driven staple tool extending at a predetermined acute angle to the wheeled carriage and to the strip which is laid upon and extends parallel to the edge of the roofing felt, the staples being applied to the strip at an acute angle to the longitudinal direction of the stapled strip.

2. An apparatus in accordance with claim 1 wherein:
a safety switch device is associated with the power driven tool and actuated by the tool being pushed against the roofing felt into an enabling condition; and
a trigger on the power driven staple tool actuates the tool to apply a staple to the roofing felt when enabled by the safety switch being in the enabled position.

3. An apparatus in accordance with claim 2 comprising:
a wheel mount for the moveable wheel on the carriage; and
the safety switch device being shifted with movement of the wheel vertically to enable the power driven staple tool for operation.

4. An apparatus in accordance with claim 1 comprising:
first wheels fixedly mounted on the carriage; and
at least one second wheel being mounted to turn on an axis spaced vertically from the axes of the first wheel;
a rocking downwardly of the second wheel causing the staple gun to push tightly against the strip and to push the strip tightly against the roofing felt at the time of application of the staple.

5. An apparatus in accordance with claim 4 comprising:
a safety switch associated with the wheel carriage and moveable to enable the staple tool for applying a staple when the wheel carriage is rocked to engage the applicator nose into its applying position.

6. An apparatus in accordance with claim 1 comprising:
a severing device on the wheeled carriage operable to sever the strip.

7. An apparatus in accordance with claim 1 comprising:
a power operated feeding device for feeding the strip forwardly to the applicator nose.

8. An apparatus in accordance with claim 1 comprising:
a strip reel device for mounting a reel of the strip rearwardly of the applicator nose.

9. An apparatus in accordance with claim 8 comprising:
a strip guide for guiding the strip from the reel device forwardly to a front portion of the wheeled carriage and then rearwardly along the front portion and then rearwardly beneath the staple tool's applicator nose.

10. An apparatus in accordance with claim 9 wherein the strip reel rolls about a horizontal axis and the reel and strip guide are in a substantially vertical plane.

11. An apparatus in accordance with claim 1 comprising:
an applicator nose on the power driven tool moveable downwardly to an applying station to engage the strip and to hold the same against the roofing felt at the time of applying a staple; and
wheels on the wheeled carriage supporting the carriage for rolling and allowing a shifting of the applicator nose from a rolling position with the nose lifted upwardly relative to the applying position at which the power driven applicator drives the staples into the strip.

12. An apparatus in accordance with claim 1 comprising:
a safety sensor moveable from a safety position preventing operation of the staple tool when the carriage is lifted from the roofing felt.

13. An apparatus in accordance with claim 1 comprising:
an automatic firing mechanism for actuating the tool to apply staples at predetermined increments of tool travel along the roof.

14. An apparatus in accordance with claim 1 comprising:
an automatic actuator mechanism for actuating the staple tool to drive the staple into the strip at equally spaced intervals along the strip.

15. An apparatus for applying a strip and fasteners to secure felt roofing material to a roof;
a moveable carriage for moving along the roofing material;
a reel for carrying the strip mounted for rotation on the carriage to allow unwinding of the strip from the reel;
a power driven applicator driver mounted on the carriage and having an applicator end for engaging the strip and holding it against the roofing material at a fastener applying position when applying the fasteners to secure the strip and roofing material to the roof;
wheels on the carriage for rolling along the roofing material as the strip is being laid on one roofing material for traveling along a straight line path of travel; and
a handle associated with the carriage for gripping by the user extending at an acute angle to the straight line path of travel to provide an ergonomic movement of the carriage with the user's lower arm being at an angle to the straight line path of travel of the carriage.

16. An apparatus in accordance with claim 15 wherein the acute angles is in the range of about 30° to 40° to the path of travel.

17. An apparatus in accordance with claim 15 wherein the power driven applicator driver comprises a pneumatic operated air cylinder and a cartridge of fasteners projecting at the acute angle.

18. An apparatus in accordance with claim 15 comprising:
a severing device for severing the strip; and
a power driven strip device to advance the strip from the reel after severing.

19. An apparatus in accordance with claim 15 comprising:
a safety sensor to sense when the carriage is removed from the roofing felt to prevent a discharge of a staple with operation of a trigger.

20. An apparatus in accordance with claim 15 wherein the strip remains in a substantially vertical plane along a path of travel from the reel to the roof.

21. An apparatus in accordance with claim 20 wherein the reel is mounted rearwardly and above the point of application of the fastener to the strip.

22. An apparatus in accordance with claim 21 wherein
a strip guide guides the strip from the reel forwardly and then downwardly to pass beneath the driver at the application point.

23. An apparatus in accordance with claim 15 wherein the power driven applicator tool comprises a staple gun and the fastener is a staple for stapling the strip and roofing material to the underlying roof.

24. An apparatus in accordance with claim 15 comprising a cutter for cutting the strip fed from the reel.

25. An apparatus in accordance with claim 15 comprising:
a powered strip advance device to advance the strip from the reel.

26. An apparatus in accordance with claim 25 wherein the powered strip advance device comprises:
a fluid cylinder and a feed pawl for engaging and feeding the strip forwardly as the fluid cylinder drives the feed pawl forwardly during its stroke.

27. An apparatus in accordance with claim 15 wherein the power driven applicator extends at an angle to the wheeled carriage and to the length of the strip and an adjacent edge of the roof felting material.

28. An apparatus in accordance with claim 27 wherein the fastener is a staple and the power drive applicator drives the staples into strip to be oriented at an acute angle to the longitudinal length of the strip as the power driven applicator is angled to the wheeled carriage.

29. An apparatus in accordance with claim 15 comprising a reel of extruded, plastic strip wound on the strip, the plastic strip having UV resistance, tensile strength and tear resistance to withstand wind loads of up to 60 mph applied to the edge of the felting material.

30. An apparatus in accordance with claim 15 comprising:
an automatic firing mechanism for actuating the applicator driver to apply fasteners at predetermined intervals of travel of the carriage along the roof.

31. An apparatus in accordance with claim 15 comprising:
an automatic actuator mechanism for measuring the travel of the carriage and the length of the strip laid and for actuating the power driven applicator driver to drive the fastener into the strip at equal intervals.

32. An apparatus for applying a strip in a straight line and for applying fasteners to secure a roofing material to a roof comprising:
a wheeled carriage for rolling along the roofing material in a forward direction;
a reel for the strip mounted on carriage and disposed in a substantially vertical plane with the strip being fed from the reel and traveling in the substantially vertical plane as the strip is being laid onto the roofing material as the carriage rolls therealong;
a reel support mounting the reel to rotate about a horizontal axis as the strip is unwound from the reel;
a selectively operated fastener applicator tool mounted on the carriage and being carried thereby for applying fasteners to secure the strip and roofing material to the roof;
a supply of fasteners associated with the fastener applicator tool and carried by the carriage; and
a strip guide for feeding the tape to travel forwardly and downwardly in a substantially common vertical plane from the reel to the point of application to the roofing material to avoid bending the strip laterally as it is fed from the reel past the fastener application point to the roofing material.

33. An apparatus in accordance with claim 32 comprising:
an automatic firing mechanism for actuating the applicator tool to apply fasteners at predetermined intervals of travel of the carriage along the roof.

34. A method of applying a strip and securing it with fasteners to a roofing felt and an underlying roof, the method comprising:
providing a wheeled carriage having a reel of strip and carrying a fastener device for applying the fasteners to the strip;
rolling the wheeled carriage along the roof;
unwinding strip from the reel as the carriage travels along the roof;
applying the strip to the roofing felt by a power driven tool at spaced locations of the wheel carriage traveling along the roof along a straight line path of travel;
holding a handle on the carriage at an acute angle to the straight line path of travel; and
applying a fastener to the strip to secure the strip and roofing felt to the roof.

35. A method in accordance with claim 34 comprising:
providing a safety sensor on the wheeled carriage for conditioning the fastener device for applying the fastener; and
for disabling the fastener device when the carriage is lifted from the roof.

36. A method in accordance with claim 34 wherein the fastener is a staple, the method comprising:
laying the elongated strip longitudinally in the straight line which is parallel to an edge of the roofing felt; and
applying the staples to the strip at an acute angle to the straight line path.

37. A method in accordance with claim 34 comprising feeding the strip in a common vertical plane from the reel to the point of application to the roof.

38. A method in accordance with claim 37 comprising:
unwinding the strip from a reel at a rear portion of the wheeled carriage and feeding the strip forwardly to a front portion of carriage, feeding the strip downwardly to the point of application to the roof; and
traveling the carriage forwardly over the strip as it is being laid.

39. A method in accordance with claim 34 comprising:
severing the strip prior to starting a new run of laying strip to the roof.

40. A method in accordance with claim 39 comprising:
advancing the recently severed strip end forwardly by a strip feeder on the carriage toward the point of application to begin a new strip fastening run.

41. A method in accordance with claim 34 wherein the applying of a faster comprises:
pulling a trigger by a person to cause the power driven tool to apply the fastener to the strip and roofing felt.

42. A method in accordance with claim 34 wherein the applying of a fastener comprises:
automatically operating the power driven tool by an automatic firing mechanism to apply the fastener to the strip at equally spaced intervals along the strips.

43. An apparatus for fastening a strip along an edge of a roofing felt to an underlying roof support comprising:
a wheeled carriage for rolling along a path parallel to the edge of the roofing felt;
a reel of the strip being mounted to the wheeled carriage for supplying the strip to the roofing felt as the strip is unwound from the reel on the traveling wheeled carriage;
a power driven tool having a supply of fasteners and a powered driver for driving fasteners into the strip, the roofing felt and the underlying roof support; and
an automatic actuator mechanism for actuating the power driven tool to drive the fastener into the strip at equally spaced intervals along the strip.

44. An apparatus in accordance with claim 43 wherein the actuator mechanism comprises:
a measuring roller for rolling along the roof and for measuring the distance of travel of the wheeled carriage and the length of the strip being applied.

45. An apparatus in accordance with claim 43 wherein the actuator mechanism comprises:
a cam operated device associated with the measuring roller for actuating the power tool at the equally spaced intervals.

46. An apparatus in accordance with claim 45 wherein the cam operated device comprises:
an actuator pin mounted on the measuring roller; and
an actuator having a cam surface thereon for engaging the actuator pin and for actuating the power driven tool.

47. An apparatus in accordance with claim 46 comprising:
a trigger on the power driven tool operable by the actuator to apply a fastener to the strip.

48. An apparatus in accordance with claim 43 wherein the automatic actuator mechanism can be enabled or disabled; and
a manual trigger for actuating the power driven tool to drive the fastener when the automatic actuator mechanism is disabled.

49. An apparatus in accordance with claim 46 wherein the actuator pin can be positioned in an operative position for engaging the cam surface and in an inoperative position for not engaging the cam surface.

50. A method of applying a strip and securing it with fasteners at even spaced intervals to a roofing felt and an underlying roof, the method comprising:
providing a wheeled carriage having a reel of strip and carrying a fastener device for applying the fasteners to the strip;
rolling the wheeled carriage along the roof;
unwinding strip from the reel as the carriage travels along the roof;
applying the strip to the roofing felt by a power driven tool at spaced locations of the wheel carriage traveling along the roof along a straight line path of travel;
measuring the travel of the carriage travel along the roof; and
automatically applying a fastener to the strip to secure the strip and roofing felt to the roof at evenly spaced, measured intervals along the strip.

51. An elongated strip for fastening with a staple roofing felt to a roof with fasteners comprising:
an elongated laminated strip being flexible and capable of being wound in coil for dispensing from a strip applying tool;
the strip having a length in excess of 100 feet and a width less than one inch;
the laminated strip having a thickness of about 0.010 or less;
the laminated strip withstanding a tension force of at least 50 lbs when perforated by a staple;
the laminated strip having a first plastic layer having a partially aligned molecular structure to provide tensile strength to the strip; and
a second layer laminated to the first layer and made of a soft polyfilm to stretch and hold the first layer to reduce tearing when the laminated strip is stretched and begins to tear at a staple.

52. An elongated strip in accordance with claim 51 comprising:
first layers having substantially equally thick first and second layers.
